(19) United States
(12) Patent Application Publication
(10) Pub. No.: US 2006/0227677 A1
(43) Pub. Date: Oct. 12, 2006

(54) Aberration detection device and optical pickup device provided with same

(75) Inventors: Nobuo Ogata, Higashihiroshima-shi (JP); Yasunori Kanazawa, Sakurai-shi (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/378,147

(22) Filed: Mar. 16, 2006

(30) Foreign Application Priority Data
Mar. 17, 2005 (JP) 2005-077971

(51) Int. Cl. G11B 7/00

(52) U.S. Cl. 369/44.23

(57) ABSTRACT

An aberration detection device is arranged such that a distance L2 is longer than a distance L1, where the distance L1 is a shortest distance between the optical axis and a condensed light spot SP1, and the distance L2 is a shortest distance between the optical axis and a condensed light spot SP2, and that a hologram element is rotatable about the optical axis. With this arrangement, condensing spots of light beams divided by the hologram element are optimized. Thereby, an aberration detection device and an optical pickup device provided with the same are provided, each of which can alleviate positional errors in mounting of the hologram element 102 in height along the optical axis.

This Nonprovisional application claims priority under 35 U.S.C. § 119(a) on Patent Application No. 077971/2005 filed in Japan on Mar. 17, 2005, the entire contents of which are hereby incorporated by reference.

### FIELD OF THE INVENTION

The present invention relates to (i) an aberration detection device for detecting an aberration which occurs in a condensing optical system and (ii) an optical pickup device including the aberration detection device.

### BACKGROUND OF THE INVENTION

Recently, a recording medium such as an optical disc is required to have a larger information recording capacity whose density is higher in order to record high-quality moving images and the like.

For the higher density and the larger capacity of the optical disc, there are proposed (i) a method in which a light beam having a short wavelength is used and (ii) a method in which an NA (Numerical Aperture) of an objective lens is increased, as a method for decreasing a diameter of a light beam focused onto an information recording layer of the optical disc.

As the method using the light beam whose wavelength is short, a technique using a blue-violet semiconductor laser whose wavelength is 405 nm is put into practical use. As to the method increasing the NA of the objective lens, a technique using a single objective lens having a high NA such as 0.85 is put into practical use as a result of an advanced lens designing technique and an advanced lens manufacturing technique.

Generally, the optical disc is arranged so that its information recording layer is covered by a cover layer so that the information recording layer is protected from dusts and is free from any damages. Thus, a light beam passing through the objective lens of the optical pickup device further passes through the cover layer so as to be focused on the information recording layer.

When the light beam passes through the cover layer, a spherical aberration (SA) occurs. The spherical aberration SA is expressed as follows:
SA∝d/λ·NA⁴ (1)
As expressed above, the spherical aberration SA is proportional to the thickness d of the cover layer and fourth power of the NA of the objective lens, and the spherical aberration SA is inversely proportional to the wavelength λ of a light source. Generally, the objective lens is designed so that the spherical aberration is offset, so that the spherical aberration of the light beam passing through the objective lens and the cover layer is sufficiently small.

However, when the thickness of the cover layer deviates from a predetermined value, the light beam condensed onto the information recording layer has a spherical aberration, so that a diameter of the beam increases. This raises such a problem that it is impossible to exactly read and write information.

Further, according to the foregoing expression (1), a spherical aberration more greatly varies (greater deviation ΔSA) in proportion to a thickness error Δd of the cover layer, so that it is impossible to exactly read and write information.

In order to realize higher density of recorded information in a direction of the thickness of the optical disc, a multilayered optical disc in which information recording layers are laminated has been developed. For example, the higher density has been achieved in DVD (Digital Versatile Discs) BD (Blu-ray Discs) each of which has two information recording layers. In the optical pickup device for recording/reproducing information on/from such a multilayered optical disc, it is necessary to condense the light beam onto each information recording layer of the optical disc so that a condensed light spot is sufficiently small.

In the optical disc having plural information recording layers, a distance between a surface (cover layer surface) of the disc and one information recording layer is different from a distance between the surface and another information recording layer. Thus, the information recording layers are different from each other in terms of the spherical aberration which occurs at the time when the light beam passes through the cover layer of the optical disc. In this case, according to the expression (1), a spherical aberration which occurs between the information recording layers adjacent to each other varies (deviation ΔSA) in proportion to a distance t (corresponding to d) between the information recording layers adjacent to each other.

In case of a DVD having two information recording layers, the NA of the objective lens of the optical pickup device is small (about 0.6), so that a slightly larger error Δd in the cover layer has little influence on how the spherical aberration varies (deviation ΔSA) according to the expression (1).

Thus, in the DVD device using a conventional optical pickup device whose NA is about 0.6, the thickness error Δd in the cover layer of the DVD less varies the spherical aberration (less deviation ΔSA), so that it is possible to condense the light beam onto each information recording layer so that a condensed light spot is sufficiently small.

However, even with the same thickness errors Δd in the cover layers, the spherical aberration more greatly varies in proportion to the NA. For example, if the NA is changed from 0.6 to 0.85, the spherical aberration becomes 4 times greater. Furthermore, even with the same thickness errors Δd in the cover layers, the spherical aberration becomes greater in proportion to the wavelength λ. For example, if the wavelength λ is changed from 650 nm to 405 nm, the spherical aberration becomes about 1.6 times greater. Thus, in the BD using a short wavelength light source and a high numerical aperture, the spherical aberration is about 6.4 times greater than that of the DVD.

In case of the multilayered disc, even with the same distances t between the information recording layers adjacent to each other, the spherical aberration more greatly varies (greater deviation ΔSA) in proportion to the NA of the objective lens of the optical pickup device. For example, if the NA is changed from 0.6 to 0.85, the spherical aberration varies about 4 times more greatly (greater deviation ΔSA). According to Equation (1), the difference (deviation ΔSA) between spherical aberrations of the information recording layers would be grater, if the NA is high (e.g. 0.85).

In this way, the objective lens having a high NA raises such a problem that the spherical aberration of the cover layer is not ignorable and would drop accuracy in reading information. Thus, it is necessary to correct the spherical aberration in order to realize higher-density recording with the objective lens whose NA is high.

For example, Patent Document 1 (Japanese Unexamined Patent Publication No. 171346/2000 (Tokukai 2000-171346)(publication date: Jun. 23, 2000)) discloses, as a technique for correcting the spherical aberration, a technique in which: a hologram element divides a returning light beam, having been reflected by the optical disc and being condensed onto the hologram element, into a first light beam including an optical axis of the light beam and a second light beam including a component outer than the optical axis, and a difference between a position in which the first light beam is condensed and a position in which the second light beam is condensed is used to detect and correct the spherical aberration.

With reference to FIG. 17 through FIG. 20, the following explains principles of the detection and the correction of the spherical aberration in the optical pickup device.

As illustrated in FIG. 17, an optical pickup device 100 includes a semiconductor laser 101, a hologram element 102, a collimator lens 103, an objective lens 104, and an optical detection section 107. The hologram element 102, the collimator lens 103, and the objective lens 104 are disposed in an optical axis OZ which is positioned between an emission surface of the semiconductor laser 101 and a reflection surface of the optical disc 106, and the optical detection section 107 is disposed in the vicinity of a position in which diffracted light from the hologram 102 is condensed.

Thus, in the optical pickup device 100, light emitted from the semiconductor laser 101 (hereinafter, referred to as “light beam”) passes through the hologram element 102 as zero order diffracted light, and the zero order diffracted light is converted into parallel light by the collimator lens 103, and the parallel light is condensed onto a predetermined position on the optical disc 106 via the objective lens 104. While, a light beam reflected by the optical disc 104 (hereinafter, referred to as “returning light”) is passes through the objective lens 104 and the collimator lens 103 and becomes incident on the hologram element 102, and the incident light is diffracted by the hologram element 102 so as to be condensed on the optical detection section 107.

As illustrated in FIG. 18, the hologram element 102 is divided into three regions 102a, 102b, and 102c. The region 102a is a semicircle region which is surrounded by a straight line CL orthogonal to the optical axis OZ and a first arc C1 (whose radius is c1) centered about the optical axis OZ. Further, the region 102b is surrounded by the first arc C1, the straight line CL, and a second arc C2 (whose radius is c2) which has a larger radius than the radius c1 and is positioned on the same side on which the first arc C1 is positioned. Further, the region 102c is a semicircle region surrounded by (i) a third are C3 (radius c2) positioned opposite to the second arc C2 with the straight line CL therebetween and (ii) the straight line CL.

The hologram element 102 transmits the light having been emitted from the semiconductor laser 101 toward the optical disc 106 without diffracting the emitted light, and the hologram element 102 diffracts the returning light from the optical disc 106 so as to lead the diffracted light to the optical detection section 107. The returning light from the optical disc 106 passes through the three regions 102a to 102c, so that condensed light spots SP1, SP2, and SP3 are formed on the optical detection section 107.

As illustrated in FIG. 19, the optical detection section 107 is constituted of five light receiving regions 107a to 107e. A first light receiving section is constituted of the light receiving regions 107a and 107b which are juxtaposed with each other. A second light receiving section is constituted of the light receiving regions 107c and 107d which are juxtaposed with each other. A third light receiving section is constituted only of the light receiving region 107e. The condensed light spot SP1 is formed on a border between the light receiving regions 107a and 107b. The condensed light spot SP2 is formed on a border between the light receiving regions 107c and 107d. The condensed light spot SP3 is formed on the light receiving region 107e.

In the light receiving regions 107a to 107e, optical signals of the received light are converted into electric signals Sa to Se. The electric signals Sa to Se obtained in the light receiving regions 107a to 107e are used to adjust movement of the objective lens 4.

When light is completely focused on the optical disc 106 (completely focused state) under such condition that the thickness and the like of the cover layer of the optical disc 106 are suitable and there is no spherical aberration, sizes of the condensed light spots SP1 to Sp3 respectively formed on the light receiving regions 107a to 107e are substantially equal with each other as illustrated in FIG. 19(b).

In this case, the condensed light spot SP1 is formed so that radiation areas of the light receiving regions 107a and 107b are equal with each other. That is, a value of the electric signal Sa obtained from the light receiving region 107a and a value of an electric signal Sb obtained from the light receiving region 107b are equal with each other.

A focus error signal FES indicative of a focus error of the light beam radiated to the optical disc 106 is expressed as FES=Sa−Sb.

Thus, when a value of the electric signal Sa obtained from the light receiving region 107a and a value of the electric signal Sb obtained from the light receiving region 107b are equal with each other, that is, when the light is in the completely focused state, the focus error signal FES is 0.

In case where a focus of the light beam radiated to the optical disc 106 deviates, each of the condensed light spots SP1 to SP3 respectively formed on the light receiving regions 107a to 107e expands in a semicircular manner. For example, when the optical disc 106 approaches the objective lens 104, the condensed light spot SP1 expands on the light receiving region 107a in a semicircular manner as illustrated in FIG. 19(a). In contrast, when the optical disc 106 moves away from the objective lens 104, the condensed light spot SP1 expands on the light receiving region 107b in a semicircular manner as illustrated in FIG. 19(c).

That is, in case where the optical disc 106 approaches the objective lens 104, the electric signal Sa has a larger value than a value of the electric signal Sb, so that the focus error signal FES has a positive value. While, in case where the optical disc 106 moves away from the objective lens 104, the electric signal Sb has a larger value than a value of the electric signal Sa, so that the focus error signal FES has a negative value.

Generally, in case where the thickness and the like of the cover layer of the optical disc 106 are not suitable, the spherical aberration occurs in the objective lens 104 of the optical pickup device arranged in the foregoing manner. In this case, as illustrated in FIG. 20(a) and FIG. 20(b), even when the objective lens 104 is in the completely focused state, that is, even when a difference between the electric signals of the light receiving regions 107a and 107b is 0, a difference between the electric signals of the light receiving regions 107c and 107d is not 0 but has a positive or negative value. This means that positive or negative spherical aberration occurs.

In case where the cover layer of the optical disc 106 has the thickness different from a predetermined size and the thickness results in positive spherical aberration under such condition that a focus actuator (not shown) drives the objective lens 104 so that the focus error signal FES is 0, a peripheral light beam of the objective lens 104 varies in the same manner as in case where the optical disc 106 approaches the objective lens 104. Thus, a shape of the condensed light spot SP2 of the light receiving regions 107c and 107d expands on the light receiving region 107c in a semi-doughnut manner as illustrated in FIG. 20(a).

Adversely, in case where negative spherical aberration occurs, a peripheral light beam of the objective lens 104 varies in the same manner as in the case where the optical disc 106 moves away from the objective lens 104. Thus, a shape of the condensed light spot SP2 of the light receiving regions 107c and 107d expands on the light receiving region 107d in a semi-doughnut manner as illustrated in FIG. 20(b).

Thus, in case where the focus error signal FES is kept to be 0, a spherical aberration signal SA which is a signal indicative of spherical aberration occurring in the objective lens 104 is expressed as follows by using electric signals Sa to Se obtained from the light receiving regions 107a to 107e:
SA=Sc−Sd

In case where the focus error signal FES is not kept to be 0, the spherical aberration signal SA is expressed as follows in consideration for the focus error signal FES:
SA=(Sa−Sb)−(Sc−Sd)×K

(K is a constant number)

If correction is made so that there is no spherical aberration in the objective lens 104 on the basis of the spherical aberration signal SA in this way, it is possible to favorably reproduce information recorded in the optical disc 106.

However, the aberration detection device disclosed in Patent Document 1 is arranged so that: as illustrated in FIG. 18, as to positions in which light beams divided by the hologram element 102 are respectively condensed onto the optical detection section 107, a shortest distance between the optical axis OZ and an optical axis of the condensed light spot SP1 whose light has been directed from the region 102a is set to be larger than a shortest distance between the optical axis OZ and an optical axis of the condensed light spot SP2 whose light has been directed from the region 102b.

In this case, if a position in which the hologram element 102 is provided has a height error in a direction of the optical axis (i.e., a positional error in mounting of the hologram element 102 in height along the optical axis), a detection error occurs in the spherical aberration error signal, so that it is impossible to exactly detect the spherical aberration.

Moreover, an actual optical pickup device has a size error in a face on which the hologram element is provided. It is possible to cover the size error by three-dimensionally adjusting the hologram element also in the direction of the optical axis, but this arrangement has a complicate mechanism which prevents the size reduction and which makes it impossible to realize the lower cost. Thus, it is general that the hologram element is merely two-dimensionally adjusted in a face orthogonal to the optical axis. Particularly, in case of applying this arrangement to an integrated module arranged so that the light source and the optical detection section are integrated with each other and the hologram element is fixed directly on other optical part in order to realize a smaller-size optical pickup device, it is more difficult to make adjustment in the direction of the optical axis.

### SUMMARY OF THE INVENTION

The present invention was made in view of the foregoing problems, and an object of the present invention is to provide an aberration detection device and an optical pickup device using this aberration detection device. The aberration detection device is arranged such that a position in which each of light beams divided by the hologram element is condensed is optimized, so that an error in a height at which a hologram element is provided in a direction of an optical axis becomes less influential.

In order to attain the object, an aberration detection device according to the present invention is provided with a division section for dividing, into a first light beam and a second light beam, a light beam having passed through a condensing optical system, where the first light beam is that component of the light beam which includes an optical axis of the light beam and the second light beam is an outer component of the light beam than the optical axis; and a spherical aberration detection section for detecting spherical aberration of the condensing optical system from radiation positions of the first and second light beams, where the radiation positions are those positions on a detection section on which the first and second light beams are radiated. The aberration detection device according to the present invention is further arranged such that a shortest distance between the optical axis and the radiation position of the second light beams is longer than a shortest distance between the optical axis and the radiation position of the first light beam, and at least one of the division section and detection section is rotatable about the optical axis.

The spherical aberration occurs in the light beam having passed through the condensing optical system including an objective lens. By the division section, the light beam is divided into the first light beam and the second light beam. The first light beam is that component of the light beam which includes an optical axis of the light beam and the second light beam is an outer component of the light beam than the optical axis. The first light beam and the second light beam are respectively received at different positions (radiation positions). Based on the radiation positions, influence on the spherical aberration can be corrected.

However, if the division section was mounted with positional error in height along the optical axis, this would lead to out-of-focusing. This out-of-focusing causes offset. As a result, the detection of the spherical aberration cannot be performed without errors, thereby becoming inaccurate.

Therefore, it is necessary to eliminate the offset. For example, the detection section may be moved parallel in order to eliminate the offset in the first light beam. However, this cannot eliminate offset in the second light beam, because the radiation position of the second light beam on the detection section is not moved enough to eliminate the offset in the second light beam.

With this arrangement, the division section is rotatable about the optical axis. The rotation of the division section causes the radiation positions of the first and second light beams on the detection mean to move about the optical axis.

In this arrangement, the shortest distance between the optical axis and the radiation position of the second light beams is longer than a shortest distance between the optical axis and the radiation position of the first light beam. With this arrangement, the rotation of the division section about the optical axis causes not much movement of the radiation position of the first light beam on the detection section, but larger movement of the radiation position of the second light beam on the detection section.

Because of this, if the radiation position of the first light beam on the detection section is so moved as to eliminate the offset in the first light beam, the radiation position of the second light beam on the detection section is also moved enough to eliminate the offset in the second light beam. Thus, the offset is corrected in the signal obtained from the detection section, thereby correcting the error in the detection of the spherical aberration. Moreover, the signal is linearly changed according to a change in the spherical aberration. Thus, the spherical aberration error signal attains a constant signal sensitivity, whereby it is possible to perform stable spherical aberration control.

In order to attain the object, an optical pickup device according to the present invention is provided with: a light source; a condensing optical system for condensing, on a recoding medium, a light beams radiated from the light source; a division section for dividing, into a first light beam and a second light beam, a light beam having passed through the condensing optical system, where the first light beam is that component of the light beam which includes an optical axis of the light beam and the second light beam is an outer component of the light beam than the optical axis; a spherical aberration detection section for detecting spherical aberration of the condensing optical system from radiation positions of the first and second light beams, where the radiation positions are those positions on a detection section on which the first and second light beams are radiated; and a spherical aberration correction section for correcting the spherical aberration detected by the spherical aberration detection section. The optical pickup device according to the present invention is further arranged such that a shortest distance between the optical axis and the radiation position of the second light beams is longer than a shortest distance between the optical axis and the radiation position of the first light beam, and at least one of the division section and detection section is rotatable about the optical axis.

With this arrangement, the division section is rotatable about the optical axis. The rotation of the division section causes the radiation positions of the first and second light beams on the detection mean to move about the optical axis.

In this arrangement, the shortest distance between the optical axis and the radiation position of the second light beams is longer than a shortest distance between the optical axis and the radiation position of the first light beam. With this arrangement, the rotation of the division section about the optical axis causes not much movement of the radiation position of the first light beam on the detection section, but larger movement of the radiation position of the second light beam on the detection section.

Because of this, if the radiation position of the first light beam on the detection section is so moved as to eliminate the offset in the first light beam, the radiation position of the second light beam on the detection section is also moved enough to eliminate the offset in the second light beam. Thus, the offset is corrected in the signal obtained from the detection section, thereby correcting the error in the detection of the spherical aberration. Moreover, the signal is linearly changed according to a change in the spherical aberration. Thus, the spherical aberration error signal attains a constant signal sensitivity, whereby it is possible to perform stable spherical aberration control.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a plan view illustrating a relationship between a hologram element and an optical detection section that are used in an optical pickup device of Embodiment 1 of the present invention.

FIG. 2 schematically illustrates a structure of an optical disc recording/reproducing device having the optical pickup device.

FIG. 3 schematically illustrates an optical system of the optical pickup device.

FIG. 4 is a plan view illustrating a hologram pattern of the hologram element used in the optical pickup device.

FIG. 5(a) is a plan view illustrating a condition under which light is received so that the received light is completely focused on the optical detection section of the optical pickup device.

FIG. 5(b) is a plan view illustrating a condition under which light is received so that the received light is incompletely focused on the optical detection section of the optical pickup device.

FIG. 5(c) is a plan view illustrating a condition under which light is received in the optical detection section in case where spherical aberration occurs.

FIG. 6(a) is a plan view illustrating a condition under which light is received in the optical detection section in case where the hologram element has a positional error.

FIG. 6(b) is a plan view illustrating a condition under which light is received in case where the hologram element is deviated in a direction (Y direction) parallel to a track.

FIG. 6(c) is a plan view illustrating a condition under which light is received in case where the hologram element is rotated about an optical axis.

FIG. 7 is a graph illustrating a spherical aberration error detection signal in case where there is an error in a height at which the hologram element of the optical pickup device is provided in a direction of the optical axis (a distance L2 is four times as long as a distance L1).

FIG. 8 is a graph illustrating a spherical aberration error detection signal in case where there is an error in the height at which the hologram element of the optical pickup device is provided in the direction of the optical axis (the distance L2 is twice as long as the distance L1).

FIG. 9 is a graph illustrating a spherical aberration error detection signal in case where there is an error in the height at which the hologram element of the optical pickup device is provided in the direction of the optical axis (the distance L1 is as long as long distance L2).

FIG. 10 is a graph illustrating a spherical aberration error detection signal in case where there is an error in the height at which the hologram element of the optical pickup device is provided in the direction of the optical axis.

FIG. 11 schematically illustrates an optical system of an optical pickup device as another embodiment of the present invention.

FIG. 12 schematically illustrates an optical integrated unit of the optical pickup device.

FIG. 13 is a plan view illustrating a hologram pattern of a first polarization hologram element used in the optical pickup device.

FIG. 14 is a plan view illustrating a hologram pattern of a second polarization hologram element used in the optical pickup device.

FIG. 15 is a plan view illustrating a light receiving pattern on an optical detection section used in the optical pickup device.

FIG. 16 is a plan view illustrating a light receiving pattern on an optical detection section used in the optical pickup device.

FIG. 17 schematically illustrates an optical system of a conventional optical pickup device.

FIG. 18 is a plan view illustrating a relationship between a hologram element and an optical detection section that are used in the conventional optical pickup device.

FIG. 19(a) is a plan view illustrating a condition under which light is received in the optical detection section in case where a distance between an objective lens and an optical disc that are provided in the conventional optical pickup device is longer than a distance between the objective lens and the optical disc in a completely focused state.

FIG. 19(b) is a plan view illustrating a condition under which light is received in the optical detection section in case where the objective lens and the optical disc that are provided in the conventional optical pickup device is a completely focused state.

FIG. 19(c) is a plan view illustrating a condition under which light is received in the optical detection section in case where the distance between the objective lens and the optical disc that are provided in the conventional optical pickup device is shorter than the distance between the objective lens and the optical disc in a completely focused state.

FIG. 20(a) is a plan view illustrating a condition under which light is received in the optical detection section in case where a distance between the objective lens and the optical disc that are provided in the conventional optical pickup device when spherical aberration occurs is longer than a distance between the objective lens and the optical disc in a completely focused state.

FIG. 20(b) is a plan view illustrating a condition under which light is received in the optical detection section in case where the distance between the objective lens and the optical disc that are provided in the conventional optical pickup device when the spherical aberration occurs is shorter than the distance between the objective lens and the optical disc in the completely focused state.

FIG. 21(a) is a plan view illustrating a condition under which light is received in the optical detection section of the conventional optical pickup device in case where the hologram element has a positional error.

FIG. 21(b) is a plan view illustrating a condition under which light is received in case where the hologram element is deviated in a direction (Y direction) parallel to a track.

FIG. 21(c) is a plan view illustrating a condition under which light is received in case where the hologram element is rotated about an optical axis.

### DESCRIPTION OF THE EMBODIMENTS

### Embodiment 1

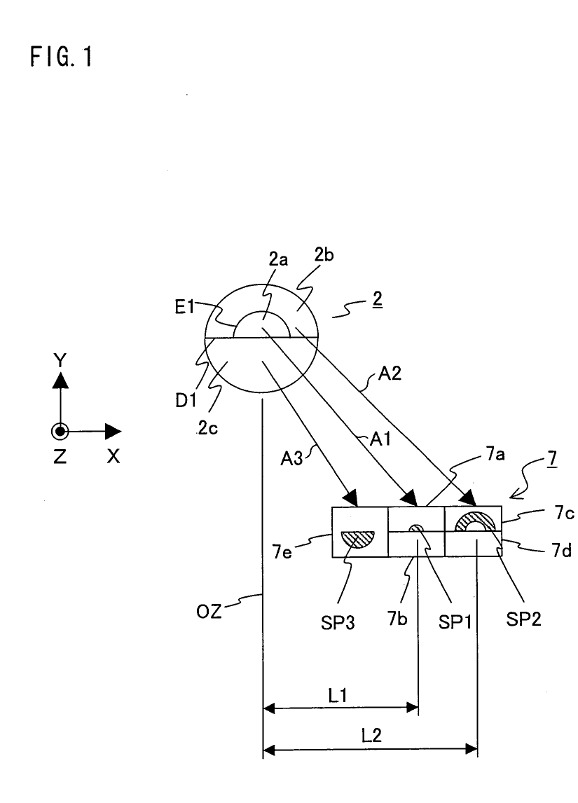

The following will describe an embodiment of the present invention in reference to FIGS. 1-10. The present embodiment discusses an example in which the invention is applied to an optical pickup device in an optical recording/reproduction device which optically records and/or reproduces information onto/from a multi-layer recording medium (e.g. optical discs such as DVD (Digital Versatile Disc) and BD (Blue-ray Disc)).

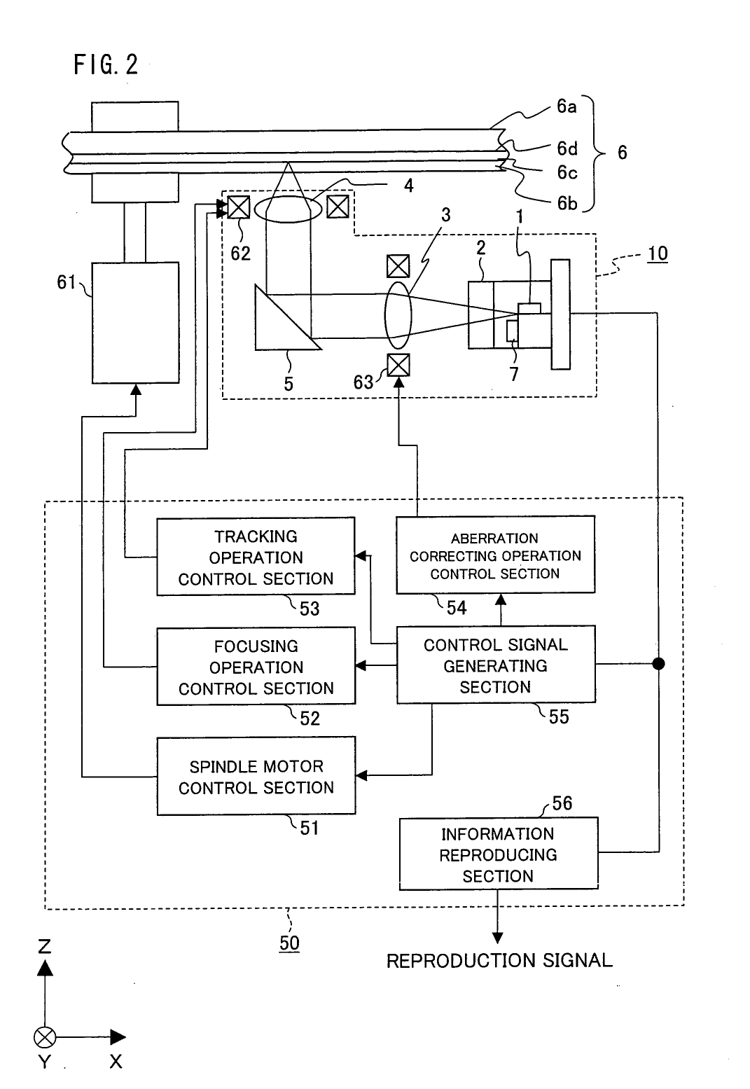

As shown in FIG. 2, an optical recording/reproduction device of the present embodiment includes: a spindle motor 61 that rotates an optical disc 6 (recording medium); an optical pickup device 10 that records and/or reproduces information onto/from the optical disc 6; and a drive control section 50 that controls the spindle motor 61 and the optical pickup device 10.

The optical disc 6 includes a base plate 6a, a cover layer 6b though which a light beam passes, and information recording layers 6c and 6d formed between the base plate 6a and the cover layer 6b. The optical pickup device 10 causes a light beam to focus on the information recording layers 6c and 6d, so that information is reproduced from the information recording layers, and/or information is recording onto the information recording layers.

The description below assumes that an information recording layer of the optical disc 6 indicates either one of the information recording layers 6c and 6d, and the optical pickup device 10 can record/reproduce information onto/from either one of the information recording layers 6c and 6d, by causing a light beam to focus on the information recording layer accordingly. Although the optical disc in the present embodiment is two-layered, it may include three or more layers.

The optical pickup device 10 includes a semiconductor laser 1 (light source), a hologram element 2 (division means), a collimating lens 3, an objective lens 4 (condensing optical system), a mirror 5, a light detection section 7 (detection means), an objective lens drive mechanism 62, and a spherical aberration correction mechanism 63.

The drive control section 50 includes: a spindle motor control section 51 that controls the spindle motor 61; a focusing operation control section 52 and a tracking operation control section 53, which control the objective lens drive mechanism 62; an aberration correcting operation control section 54 that controls the spherical aberration correction mechanism 63; a control signal generating section (spherical aberration detection means 55 that generates control signals supplied to the spindle motor control section 51, the focusing operation control section 52, the tracking operation control section 53, and the aberration correcting operation control section 54; and an information reproducing section 56 that reproduces information from signals supplied from the light detection section 7, so as to generate a reproduction signal.

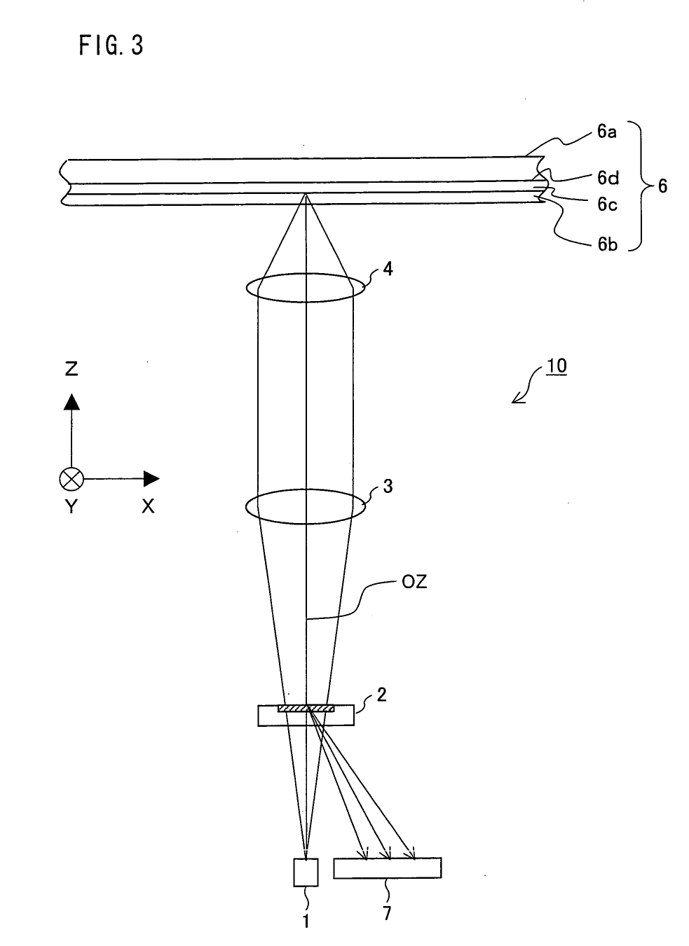

The members of the optical pickup device 10 will be described in reference to FIGS. 2 and 3.

The semiconductor laser 1 is a light source that emits a laser (hereinafter, light beam) onto the optical disc 6. An wavelength λ of the light beam is, for example, 405 nm.

As shown in FIG. 3, the hologram element 2 allows, without diffraction, a light beam supplied from the semiconductor laser 1 to pass through. On the other hand, the hologram element 2 diffracts reflected light (hereinafter, return light) coming from the optical disc 6, so as to guide the diffracted light to the light detection section 7. A hologram pattern of the hologram element 2 will be described later.

The collimating lens 3 causes a light beam and return light, which come from the hologram element 2 and the objective lens 4, respectively, to be in parallel to an optical axis.

The mirror 5 diffracts the light path of the light beam coming from the collimating lens 3, so as to guide the diffracted light to the objective lens 4. Also, the mirror 5 guides return light from the objective lens 4 on the optical disc 6 side to the collimating lens 3.

The objective lens 4 (i) causes the light beam, which is caused to be in parallel with the optical axis by the collimating lens 3, to focus on the optical disc 6, and (ii) guides the return light from the optical disc 6 to the mirror 5.

The objective lens drive mechanism 62 moves the objective lens 4 in an optical axis direction (Z direction) and a tracking direction (X direction), in response to signals from the focusing operation control section 52 and the tracking operation control section 53. On this account, even if surface runout or eccentricity of the optical disc 6 occurs, a condensed light spot (light applying position) keeps track of a predetermined position on the information recording layer 6c or information recording layer 6d.

The spherical aberration correction mechanism 63 moves the collimating lens 3 in the optical axis direction, in response to a signal supplied from the aberration correcting operation control section 54. By doing so, the spherical aberration correction mechanism 63 corrects spherical aberration in the optical system of the optical pickup device 10.

The light detection section 7 receives the light diffracted by the hologram element 2. In the present embodiment, the light detection section 7 locates on the hologram element 2 and at a focusing position of plus first order light. This arrangement will be described in detail later.

Now, the members of the drive control section 50 will be discussed.

The control signal generating section 55 generates a spindle motor drive control signal, a focus error signal FES, a tracking error signal TES, and a spherical aberration error signal SAES, in response to signals supplied from the light detection section 7. The control signal generating section 55 sends the spindle motor drive control signal to the spindle motor control section 51, the focus error signal FES to the focusing operation control section 52, the tracking error signal TES to the tracking operation control section 53, and the spherical aberration error signal SAES to the aberration correcting operation control section 54, respectively. These control sections controls the corresponding members, in line with the supplied respective signals.

More specifically, receiving the spindle motor drive control signal, the spindle motor control section 51 controls the spindle motor 61, in accordance with the received signal. Meanwhile, receiving the focus error signal FES, the focusing operation control section 52 controls the objective lens drive mechanism 62, in accordance with the received signal FES. As a result, the objective lens drive mechanism 62 moves the objective lens 4 in the optical axis direction, so as to correct focal point deviation of the objective lens 4.

Receiving the spherical aberration error signal SAES, the aberration correcting operation control section 54 controls the spherical aberration correction mechanism 63, in accordance with the received signal SAES. As a result, the spherical aberration correction mechanism 63 moves the collimating lens 3 in the optical axis direction, so as to correct spherical aberration occurring in the optical system of the optical pickup device 10.

The following will describe a light path in the optical pickup device 10 of the present embodiment.

A light beam emitted by the semiconductor laser 1 passes through the hologram element 2. The light beam passing through the hologram element 2 is zero order diffraction light. Then the light beam is converted to parallel light, and passes through the objective lens 4. After passing thorough the objective lens 4, the light beam focuses on the information recording layer 6c or 6d of the optical disc 6, and reflected thereon.

In the meanwhile, the return light from the information recording layer 6c or 6d of the optical disc 6 passes through the objective lens 4 and the collimating lens 3 in this order, and enters the hologram element 2. The light is diffracted by the hologram element 2, and then focuses on the light detection section 7.

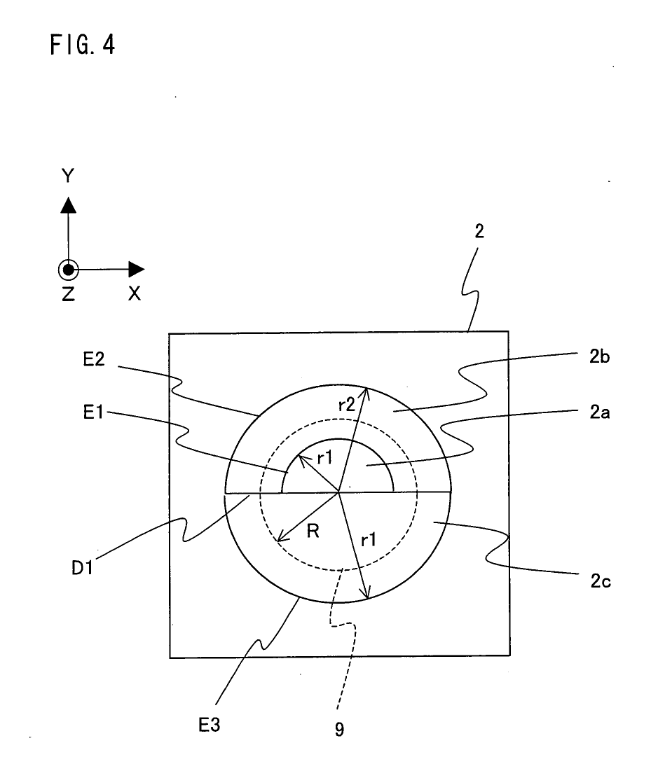

Now, referring to FIG. 4, a hologram pattern formed by the hologram element 2 will be discussed.

As shown in FIG. 4, the hologram element 2 is divided into three areas 2a, 2b, and 2c. The area 2a is a half circle formed by (i) a straight line D1 orthogonal to an optical axis OZ and (ii) a first arc E1 (which is r1 in radius) centered about the optical axis OZ. The area 2b is circumscribed by (i) the first arc E1, (ii) the straight line D1, and (iii) a second arc E2 which has a radius r2 longer than the radius r1 and is provided on the same side on which the first arc E1 is provided. The area 2c is a half circle which is formed by (i) a third arc E3 (which is r2 in radius) and is positioned opposite to the second arc E2 with respect to the straight line D1, and (ii) the straight line D1. Provided that an effective radius R in consideration of the aperture of the objective lens 4 on the hologram element 2 is 9, the sensitivity of the spherical aberration error signal is maximized by setting r1=0.7R. The radius r2 is set so as to be sufficiently longer than the effective radius R, in consideration of shifting of the objective lens and an alignment error.

The following will describe how the light detection section 7 is arranged.

As shown in FIG. 1, the light detection section 7 includes five light receiving areas 7a-7e. Among return light reflected on the information recording layer 6c or 6d, plus first order diffraction light of the return light having passed through the area 2a of the hologram element 2 forms a condensed light spot SP1 on the border between the light receiving areas 7a and 7b. Plus first order diffraction light of the return light having passed through the area 2b forms a condensed light spot SP2 on the border between the light receiving areas 7c and 7d. Plus first order diffraction light of the return light having passed through the area 2c forms a condensed light spot SP3 in the light receiving area 7e. A hologram pattern of the hologram element 2 is designed in such a manner as to cause the plus first order diffraction light to form the respective condensed light spots SP1, SP2, and SP3. The plus first order diffraction light forming the condensed light spot SP1 is termed diffraction light A1 (first light beam). The plus first order diffraction light forming the condensed light spot SP2 is termed diffraction light A2 (second light beam). The plus first order diffraction light forming the condensed light spot SP3 is termed diffraction light A3. At the focal points, on the light detection section 7, of the respective diffraction light A1, A2, and A3, a hologram pattern of the hologram element 2 of the present embodiment is arranged as L2>L1 where L1 is the shortest distance between the optical axis OZ and the optical axis of the diffraction light A1 and L2 indicates the shortest distance between the optical axis OZ and the optical axis of the diffraction light A2.

Five light receiving areas 7a-7e of the light detection section 7 convert the received diffraction light into electric signals, respectively, and send the signals to the control signal generating section 55. Based on the supplied electric signals, the control signal generating section 55 generates control signals used for detecting and adjusting a focal point deviation and spherical aberration of the objective lens 4. The electric signal converted by the light receiving area 7a of the light detection section 7 is termed SP1a. The electric signal converted by the light receiving area 7b is termed SP1b. The electric signal converted by the light receiving area 7c is termed SP2c. The electric signal converted by the light receiving area 7d is termed SP2d. The electric signal converted by the light receiving area 7e is termed SP3e.

In addition to the above, the light receiving areas 7a-7e send the electric signals to the information reproducing section 56. The information reproducing section 56 converts the electric signals into a reproduction signal RF. As the following equation shows, the reproduction signal RF is the sum total of the above-described electric signals:
RF=SP1a+SP1b+SP2c+SP2d+SP3e

Correction of a focal point deviation in a case where spherical aberration is almost negligible is carried out using the electric signals. In this connection, a focus error signal FES is detected by a knife edge method, and the FES is worked out by the following equation:
FES=(SP1a−SP1b)+(SP2c−SP2d)

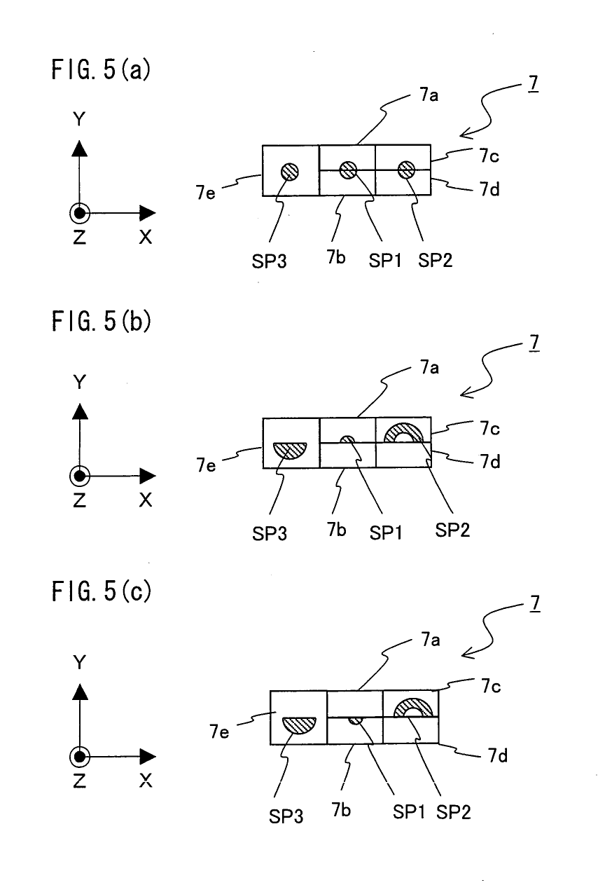

Now, the following will discuss how the focus error signal FES is detected, in reference to FIGS. 5(a)-5(c).

Assume that a light beam focuses on either one of the information recording layers 6c and 6d of the optical disc 6, i.e. a light beam condensed by the objective lens 4 this case, as shown in FIG. 5(a), the condensed light spot SP1 is formed on the border between the light receiving area 7a and the light receiving area 7b. On this account, a first output signal (SP1a-SP1b) is zero. In the meanwhile, the condensed light spot SP2 is formed on the border between the light receiving area 7c and the light receiving area 7d. On this account, a second output signal (SP2c−SP2d) is also zero. The focus error signal FES is therefore zero.

Now, assume that the distance between the objective lens 4 and the information recording layer 6c or 6d is short or long as compared to the distance in the aforesaid case where the light beam focuses on either one of the information recording layers 6c and 6d, i.e. assume that the light beam does not focus on the information recording layer 6c or 6d. In such a case, as shown in FIG. 5(b), the shapes of the respective condensed light spots SP1-SP3 are different. On this account, the first output signal (SP1a−SP1b) and the second output signal (SP2c−SP2d) have values reflecting the focal point deviation. The focus error signal FES therefore has a nonzero value reflecting the focal point deviation.

Because of the above, to always keep a focal point on the information recording layer, the objective lens 4 is moved in parallel to the optical axis OZ so that the focus error signal FES is kept to be always zero.

Now, the following discusses a case where, while deviation from a focal point does not occur in the optical system of the optical pickup device 10, spherical aberration occurs therein.

Spherical aberration also occurs (i) on account of change in the thickness of the cover layer 6b of the optical disc 6 and (ii) at the time of interlayer jump between the information recording layers 6c and 6d. The focal points of the respective diffraction light A1 and A2 are different between a case where spherical aberration occurs and a case where spherical aberration does not occur. On this account, when spherical aberration occurs, the first output signal (SP1a−SP1b) and the second output signal (SP2c−SP2d) are not zero, and hence values reflecting the spherical aberration are obtained from the respective light receiving areas 7a-7d. Also, between the diffraction light A1 and A2, deviation from a focal point on account of spherical aberration occurs in opposite directions. On this account, a spherical aberration error signal SAES with higher sensitivity is obtained by working out a difference between the first output signal (SP1a−SP1b) and the second output signal (SP2c−SP2d).

Therefore, the spherical aberration error signal SAES
SAES=(SP1a−SP1b)−k×(SP2c−SP2d)

Referring to FIGS. 5(a)-5(c), the following describes how the spherical aberration error signal SAES is detected in a case where focal point deviation does not occur in the optical system of the optical pickup device 10. The description is divided into a case where spherical aberration does not occur and a case where spherical aberration occurs.

A case where spherical aberration does not occur is discussed first. As shown in FIG. 5(a), the condensed light spot SP1 is formed on the border of the light receiving area 7a and the light receiving area 7b. On this account, the first output signal (SP1a−SP1b) is zero. The condensed light spot SP2 is formed also on the border between the light receiving area 7c and the light receiving area 7d. On this account, the second output signal (SP2c−SP2d) is zero as well. The spherical aberration error signal SAES is therefore zero.

Now, a case where spherical aberration occurs is discussed. As shown in FIG. 5(c), although focal point deviation does not occur, the condensed light spots SP1 and SP1 are in defocused states. As a result, the first output signal (SP1a−SP1b) and the second output signal (SP2c−SP2d) are not zero. Also, since defocusing occurs in opposite directions between the condensed light spots SP1 and SP2, a spherical aberration error signal SAES with high sensitivity is detected by using, as a signal, the difference between the first and second output signals.

Now, the following discusses how a spherical aberration error signal SAES is detected in a case where focal point deviation is occurring.

When focal point deviation occurs, the condensed light spots SP1 and SP2 are in defocused states on account of the focal point deviation. For this reason, the first output signal (SP1a−SP1b) and the second output signal (SP2c−SP2d) are not zero. If focal point deviation is small, changes in the first output signal (SP1a−SP1b) and the second output signal (SP2c−SP2d) are almost linear. It is therefore possible to eliminate the influence of the focal point deviation on the spherical aberration error signal SAES, by optimizing a coefficient k.

Meanwhile, in a case of spherical aberration, defocusing on account of the spherical aberration occurs in opposite directions between the condensed light spots SP1 and SP2. On this account, a spherical aberration error signal SAES is not zero even if a coefficient k is optimized.

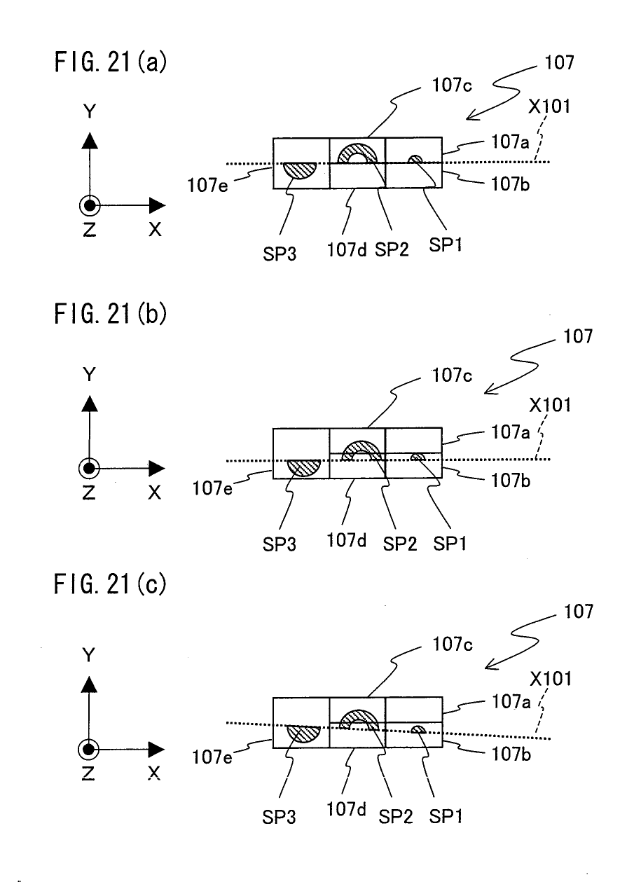

Now, referring to FIGS. 21(a)-21(c), the following will discuss an influence of a positional error of a conventional hologram element 102 in the optical axis direction.

In a case where the hologram element 102 has a positional error in the optical axis direction, as shown in FIG. 21(a), condensed light spots SP1 and SP2 on the light detection section 107 are in defocused states, even if a light beam focuses on the optical disc 106. On this account, electric signals detected by the light detection section 107 are (Sa−Sb)>0 and (Sc−Sd)>0. Therefore, a focus error signal FES is represented as follows: FES=(Sa−Sb)+(Sc−Sd)>0. A large offset therefore occurs in the focus error signal FES.

Removal of this offset is achieved by adjusting relative positions of (i) a straight line X101 connecting the centers of the respective condensed light spots SP1, SP2, SP3, (ii) the border line between light receiving areas 107a and 107b, and (iii) the border line between light receiving areas 107c and 107d. The adjustment is performed by either one of two adjusting methods below.

According to the first adjusting method, as shown in FIG. 21(b), the light detection section 107 is moved in a positive direction in parallel to the tracks (i.e. in Y direction). In the method, although the condensed light spot SP2 is formed across the border between the light receiving areas 107c and 107d, the condensed light spot SP1 is formed only in the light receiving area 107b. For this reason, spherical aberration is not stably controlled.

According to the second adjusting method, as shown in FIG. 21(c), the hologram element 102 is rotated around the optical axis OZ, so that the condensed light spots SP1 and SP2 are moved in a negative direction in parallel to the tracks (i.e. Y direction). In this method, since the condensed light spot SP1 is far from the optical axis OZ as compared to the condensed light spot SP2, the moving distance of the condensed light spot SP1 on account of the rotation of the hologram element 102 is longer than the moving distance of the condensed light spot SP2. For this reason, even if the condensed light spot SP2 is formed across the border between the light receiving areas 107c and 107d, the condensed light spot SP1 is formed only in the light receiving area 107b. Spherical aberration is therefore not stably controlled.

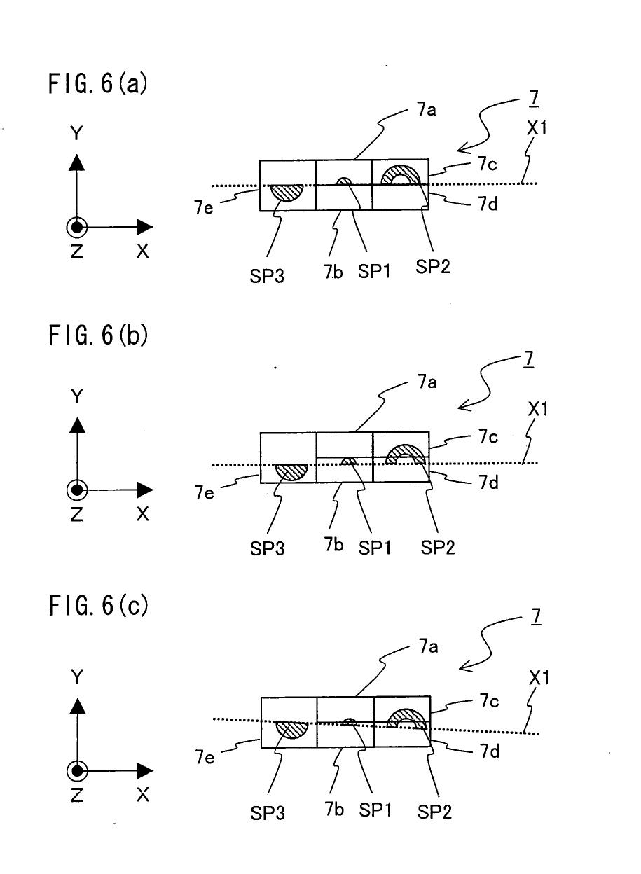

With these problems in mind, the present embodiment is arranged such that, as shown in FIGS. 6(a)-6(c), the light receiving areas 7a, 7b, 7c, and 7d are disposed in such a manner as to cause the shortest distance L2 to be longer than the shortest distance L1.

In reference to FIGS. 6(a)-6(c), the following describes an influence of a positional error in the optical axis direction, which occurs in the hologram element 2

In a case where the hologram element 2 has a positional error in the optical axis direction, as FIG. 6(a) shows, the condensed light spots SP1 and SP2 on the light detection section 7 are both in defocused states, even if a light beam focuses on the information recording layer 6c or 6d. Therefore, the first output signal (SP1a−SP1b) is larger than 0, and the second output signal (SP2c−SP2d) is also larger than 0. On this account, a focus error signal FES is represented as: FES=(SP1a−SP1b)+(SP2c−SP2d)>0, and hence a large offset occurs in the focus error signal FES.

Removal of this offset is achieved by adjusting relative positions of (i) a straight line X11 connecting the centers of the respective condensed light spots SP1, SP2, SP3, and (ii) the border line between light receiving areas 7a and 7b, and of (i) the straight line X1 and (iii) the border line between light receiving areas 7c and 7d. The adjustment is performed by either one of two adjusting methods below.

According to the first adjusting method, as shown in FIG. 6(b), although the condensed light spot SP2 of the diffraction light A2 is formed across the border between the light receiving areas 7c and 7d, the condensed light spot SP1 of the diffraction light A1 is formed only in the not stably controlled.

To solve this problem, as shown in FIG. 6(c), the second adjusting method is used. According to this method, the condensed light spot SP1 is formed not only in the light receiving area 7b but also across the border between the light receiving areas 7a and 7b, while the condensed light spot SP2 is formed across the border between the light receiving areas 7c and 7d. As a result, an effect of offset correction is exerted to the first output signal (SP1a−SP1b) and the second output signal (SP2c−SP2d), and hence an error in spherical aberration detection is corrected. Moreover, since the first output signal (SP1a−SP1b) and the second output signal (SP2c−SP2d) linearly change in response to a change in spherical aberration, Signal sensitivity of a spherical aberration error signal SAES is stable (SAES is worked out as a difference between the first and second output signals). Spherical aberration is therefore stably controlled.

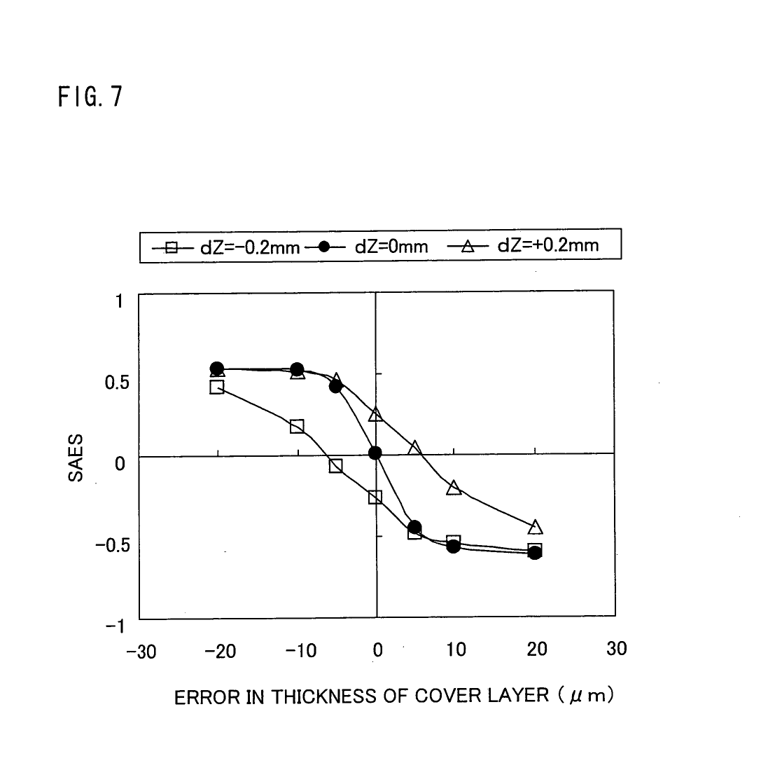

In reference to FIGS. 7-9, the following will discuss the relationship between (i) the shortest distance L1 between the optical axis OZ and the optical axis of the diffraction light A1 and (ii) the shortest distance L2 between the optical axis OZ and the optical axis of the diffraction light A2. FIGS. 7-9 are graphs showing the relationship between a spherical aberration error signal SAES and an error in the thickness of the cover layer 6b of the optical disc 6. The graphs correspond to the following three conditions: height errors Δz of the hologram element 2 in the optical axis direction are −0.2 mm, 0 mm, and +0.2 mm, respectively. A plus sign prefixed to a height error ΔZ indicates that the distance between the semiconductor laser 1 and the hologram element 2 increases, while a minus sign indicates that the distance decreases. The rotation of the hologram element 2 is adjusted in such a manner as to cause an offset of the focus error signal FES to be zero with respect to each height error ΔZ.

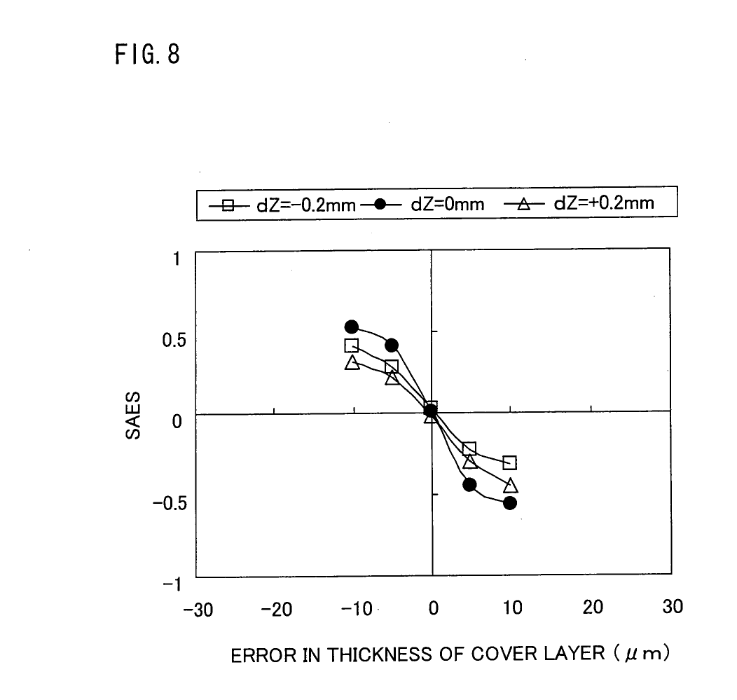

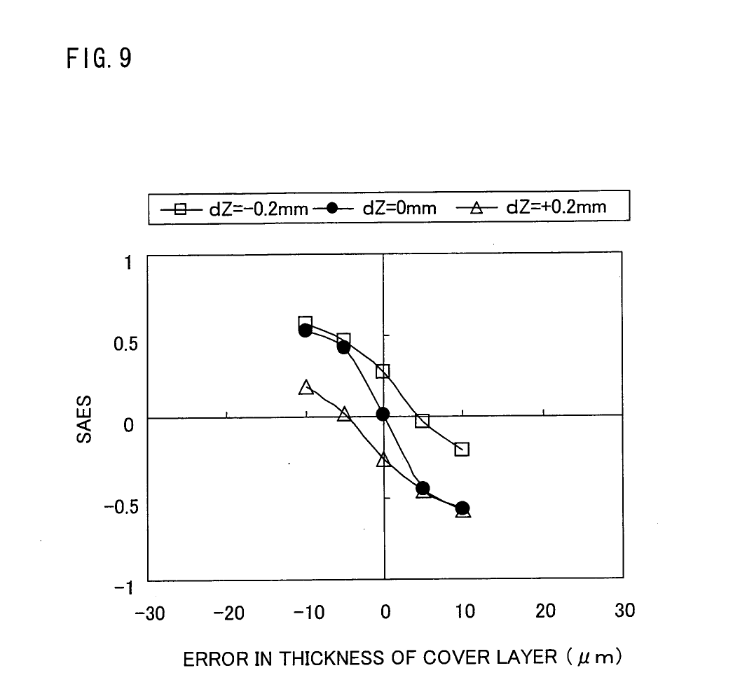

FIG. 7 shows a case where the distance L2 is four times longer than the distance L1. FIG. 8 shows a case where the distance L2 is twice as long as the distance L1. FIG. 9 shows a case where the distance L2 is identical with the distance L1.

In FIGS. 7 and 9, an error in spherical aberration detection is considerable except a case where the height error ΔZ is zero. Meanwhile, an error in spherical aberration detection scarcely occurs in FIG. 8.

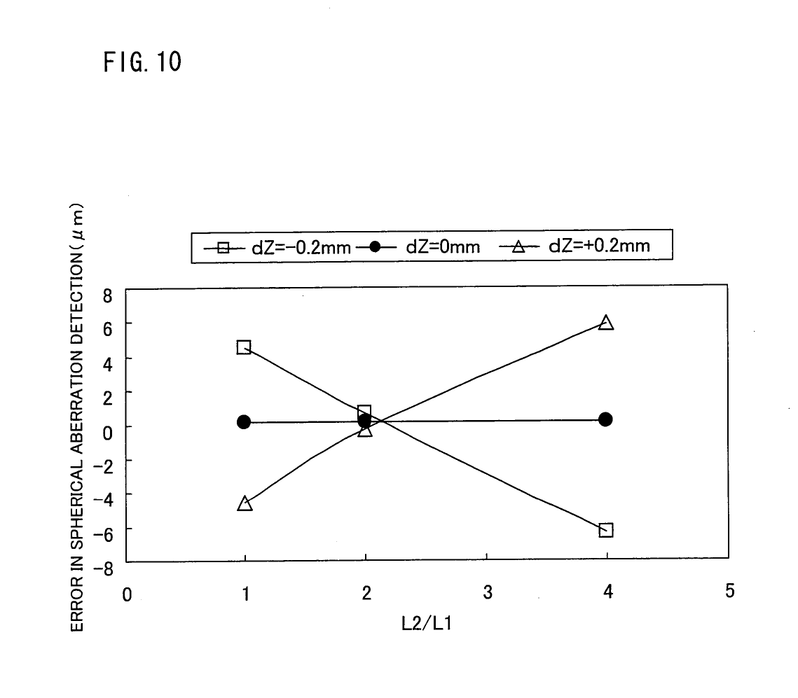

Meanwhile, FIG. 10 shows the relationship between an error in spherical aberration detection and a focal point ratio (L2/L1). The figure illustrates that an error in spherical aberration detection is minimized when the focal point ratio (L2/L1) is around 2.

In the present embodiment, the hologram element 2 is divided along an arc, in order to detect a spherical aberration signal. Not limited to this arrangement, the hologram element 2 may be divided along an elliptic arc, a straight line, or other types of lines. In such cases, the distances L1 and L2 are optimized in accordance with the way of division.

In the present embodiment, the hologram element 2 is used as a means for guiding, to the light detection section 7, a light beam (return light) reflected from the information recording layer 6c or 6d of the optical disc 6. Not limited to this arrangement, the guiding means may be a combination of a beam splitter and a wedge prism. However, a hologram element is preferable in consideration of the downsizing of the device.

Although the present embodiment discussed the optical pickup device 10 in which the semiconductor laser 1 is integrated with the light detection section 7, the following arrangement may be alternatively adopted: an independent semiconductor laser is used as a light source, a light path is divided by a polarized beam splitter (PBS), and reflected light of the PBS is supplied to a light detection section. In this case, light beam division means is provided in an outgoing optical system.

In the present embodiment, the spherical aberration correction mechanism is achieved by moving the collimating lens 3. Alternatively, it is possible to adopt such a mechanism that a distance between two lenses, which function as a beam expander (not illustrated) and provided between the collimating lens 3 and the objective lens 4, is adjusted.

In the present embodiment, the hologram element 2 is rotated about the optical axis OZ so that the adjustment is achieved. Not limited to this arrangement, the following arrangements may be adopted: (i) the light detection section 7 is rotated about the optical axis OZ, while the hologram element 2 is fixed; or (ii) both the hologram element 2 and the light detection section 7 are rotated about the optical axis OZ.

### Embodiment 2

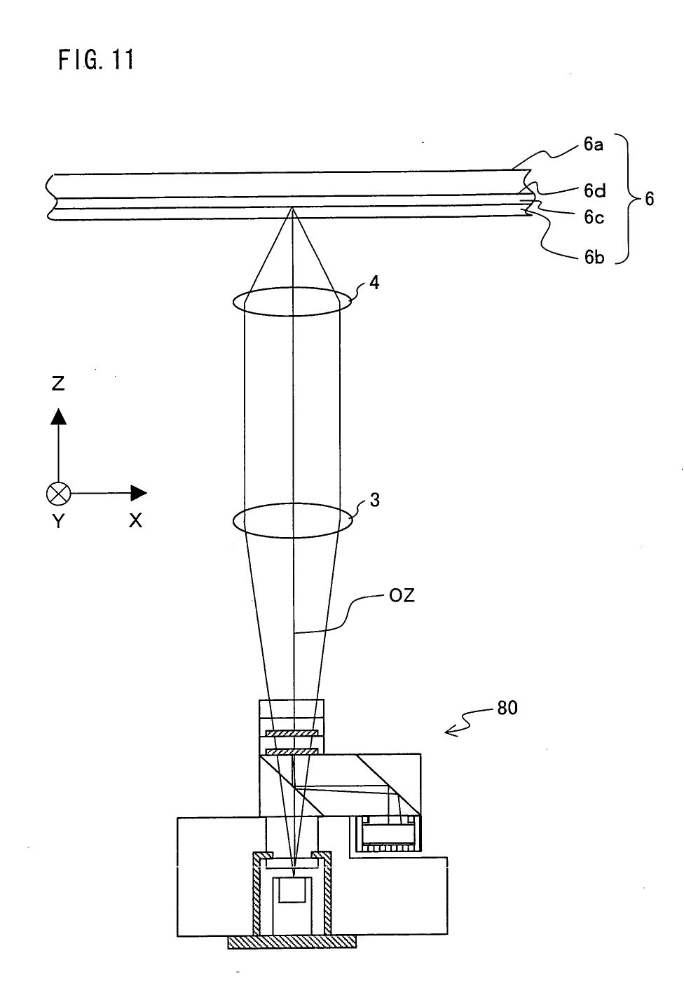

The following will describe another embodiment of the present invention in reference to FIG. 11 to FIG. 16. Here, for convenience, members of the present embodiment that have the same arrangement and function as members of embodiment 1, and that are mentioned in that embodiment are indicated by the same reference

Referring to FIG. 11, an optical pickup device provided with an optical integrated unit 80 of the present embodiment includes the optical integrated unit 80, a collimating lens 3, and an objective lens 4. A light beam radiated from the optical integrated unit 80 travels through the collimating lens 3 and the objective lens 4. The beam is condensed onto, and reflected from, an information recording layer 6c or an information recording layer 6d on an optical disc 6. The reflected light (return light) travels again through the objective lens 4 and the collimating lens 3 and is condensed onto a light detection section 27 of the optical integrated unit 80.

Now, the structure of the optical integrated unit 80 will be described.

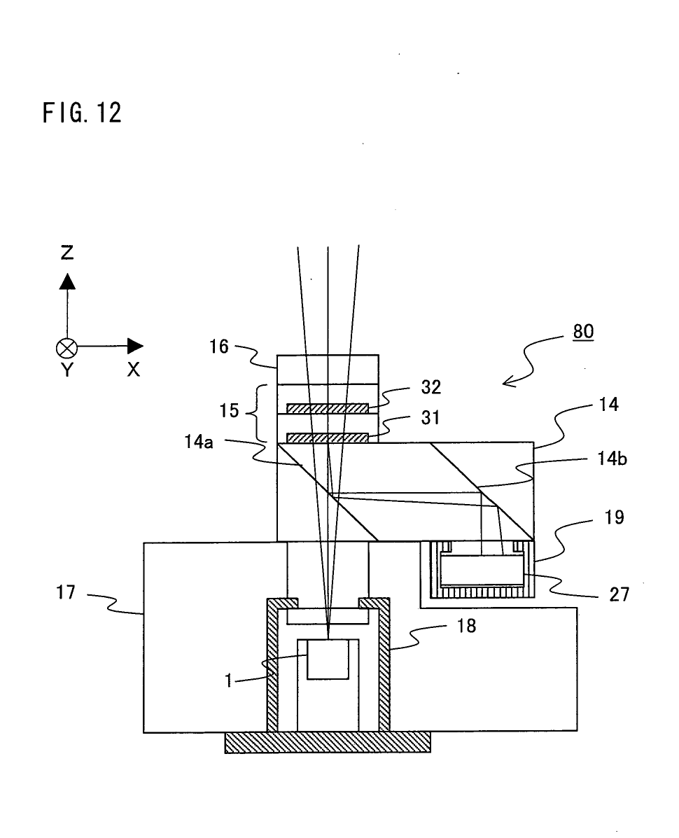

The optical integrated unit 80, as shown in FIG. 12, contains a semiconductor laser 1, a polarized beam splitter (hereinafter, “PBS”) 14, a polarize/diffract element 15, a quarter-wave plate 16, a holder 17, packages 18, 19, and a light detection section 27.

The PBS 14 includes a polarized beam splitter face (hereinafter, “PBS face”) 14a and a reflecting mirror face 14b. The PBS face 14a transmits a light beam from the semiconductor laser 1, whereas the PBS face 14a reflects a S-polarized beam diffracted by a first polarization hologram element 31 (detailed later). The reflecting mirror face 14b reflects a S-polarized beam from the PBS face 14a and guides the beam to the light detection section 27.

The polarize/diffract element 15 includes a first polarization hologram element 31 and a second polarization hologram element 32 (division means). The first polarization hologram element 31 diffracts P-polarized light, whereas the element 31 transmits S-polarized light. The element 31 has a hologram pattern for the generation of 3 beams to detect a tracking error signal TES. The second polarization hologram element 32 diffracts S-polarized light, whereas the element 32 transmits P-polarized light. More specifically, the element 32 diffracts S-polarized incident light into zero order diffraction light (non-diffraction light) and plus/minus (±) first order diffraction light (diffraction light). The hologram pattern on the first polarization hologram element 31 and the second polarization hologram element 32 will be detailed later. The elements diffract polarized light by means of a groove structure (grating) formed thereon. Diffraction angle is specified by the pitch of the grating (hereinafter, “grating pitch”).

The quarter-wave plate 16 converts incoming linearly, P-polarized light to circularly polarized light and incoming circularly polarized light to linearly, S-polarized light.

The holder 17 has a hole section in which the package 18 is housed and through which a light beam from the semiconductor laser 1 passes. The holder also has a groove section by which mechanical interference with the package 19 is avoided. The package 18 houses the semiconductor laser 1. The package 19 houses the light detection section 27.

The following will describe optical path in the optical pickup device of the present embodiment in reference to FIG. 12.

After passing through the PBS face 14a, a light beam radiated from the semiconductor laser 1 is incident on the first polarization hologram element 31. Since the light beam is linearly, P-polarized light, the beam is diffracted by the first polarization hologram element 31 into three light beams (first light beam and two second light beams). Examples of methods for detection of a tracking error signal TES using 3 beams include three beams schemes, differential push-pull (DPP), and phase shift DPP.

Since all the three light beams travel the same path until the beams is incident on the light detection section 27, the individual beams will not be distinguished for the sake of easy explanation below.

The diffracted light beam travels through the second polarization hologram element 32 and enters the to the quarter-wave plate 16 is converted from linearly, P-polarized light to circularly polarized light, transmitted through the collimating lens 3 and the objective lens 4, condensed onto, and reflected from, the information recording layer 6c or the information recording layer 6d on the optical disc 6.

The reflected light beam (hereinafter, “return light”) travels through the objective lens 4 and the collimating lens 3 and enters the quarter-wave plate 16. The light beam is converted from circularly polarized light to linearly, S-polarized light in the quarter-wave plate 16 and hits the second polarization hologram element 32. The return light of the S-polarized light is diffracted (divided) by the second polarization hologram element 32 into zero order diffraction light (non-diffraction light) and plus/minus first order diffraction light (diffraction light). The light passes through the first polarization hologram element 31, reflects from the PBS face 14a and the reflecting mirror face 14b, and enters the light detection section 27.

The following will describe a case where phase shift DPP is employed as a hologram pattern for the first polarization hologram element 31. The hologram pattern may be a regular linear grating using a three beams scheme or differential push-pull (DPP).

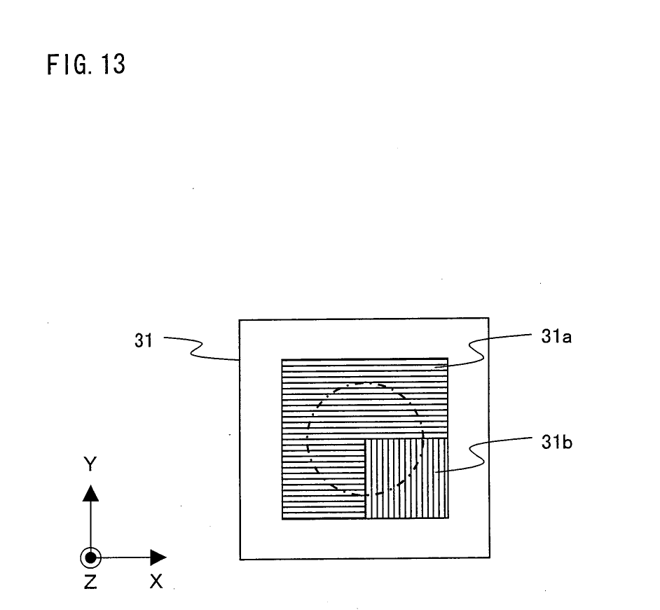

The hologram pattern on the first polarization hologram element 31, as shown in FIG. 13, has an area 31a and an area 31b. The areas 31a and 31b have a cyclic structure 180° out of phase with each other. Therefore, the push-pull signal amplitude of the second light beam is substantially zero. Offset caused by objective lens shifting and disc tilting can be cancelled. If the return light radiated onto the first polarization hologram element 31 is accurately positioned relative to the areas 31a and 31b, good offset canceling performance is achieved. If the return light has a large effective radius, misalignment of the return light relative to the areas 31a and 31b due to changes over time and with temperature does not cause large impact.

Next, the hologram pattern on the second polarization hologram element 32 will be described.

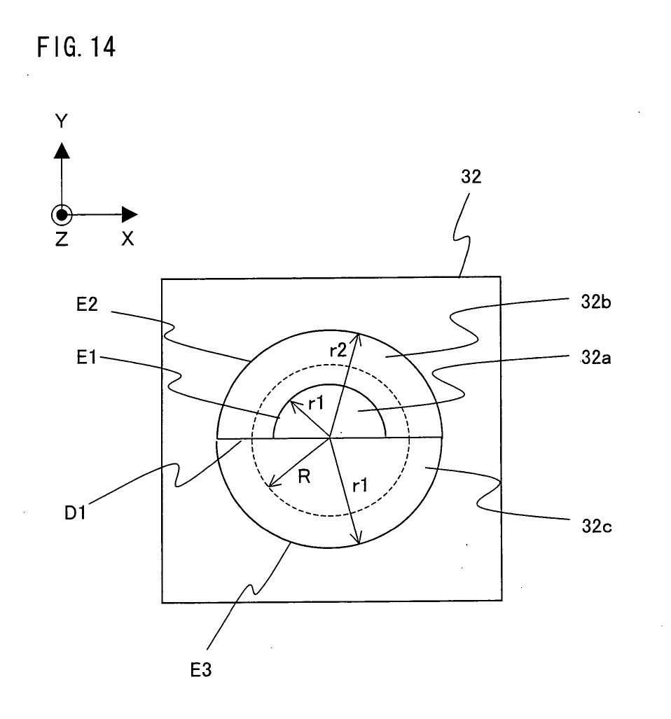

The hologram pattern on the second polarization hologram element 32, as shown in FIG. 14, is divided into three areas 32a, 32b, and 32c. The three areas 32a, 32b, and 32c are similar to the hologram pattern on the hologram element 2 in embodiment 1 above; its description is not repeated here. In the second polarization hologram element 32, a spherical aberration error signal SAES is detected using plus first order diffraction light from the areas 32a and 32b. A focus error signal FES is detected with a double knife edge scheme using plus first order diffraction light from the areas 32a, 32b, and 32c.

The first and second polarization hologram elements 31 and 32 can be fabricated integrally. In the integrated first and second polarization hologram elements 31 and 32, they are accurately positioned (aligned) by utilizing accuracy required in masking. Therefore, the positional adjustment of the first polarization hologram element 31 is completed simultaneously with such positional adjustment of the second polarization hologram element 32 that allows production of a predetermined servo signal. This facilitates adjustment and improves accuracy thereof in the assembly of the optical integrated unit 80.

Further, as shown in FIG. 14, where the second polarization hologram element 32 is divided into the areas 32a, 32b, and 32c, the ratio of the amount of light detected from the area 32a to that detected from the area 32b changes if the light beam moves in a tracking direction (X direction) on the second polarization hologram element 32. In contrast, if the light beam moves parallel to the track (Y direction), the ratio of the sum of the amounts of light detected from the areas 32a and 32b to the amount of light detected from the area 32c changes. Accordingly, based on the ratio, the second polarization hologram element 32 can be positioned relative to the center of the light beam or return light, or vice versa. Therefore, no divide pattern needs be formed for the purpose of positioning. The focus error signal FES can be detected with a double knife edge scheme using all the footprint of the light beam, which enables stable focus control.

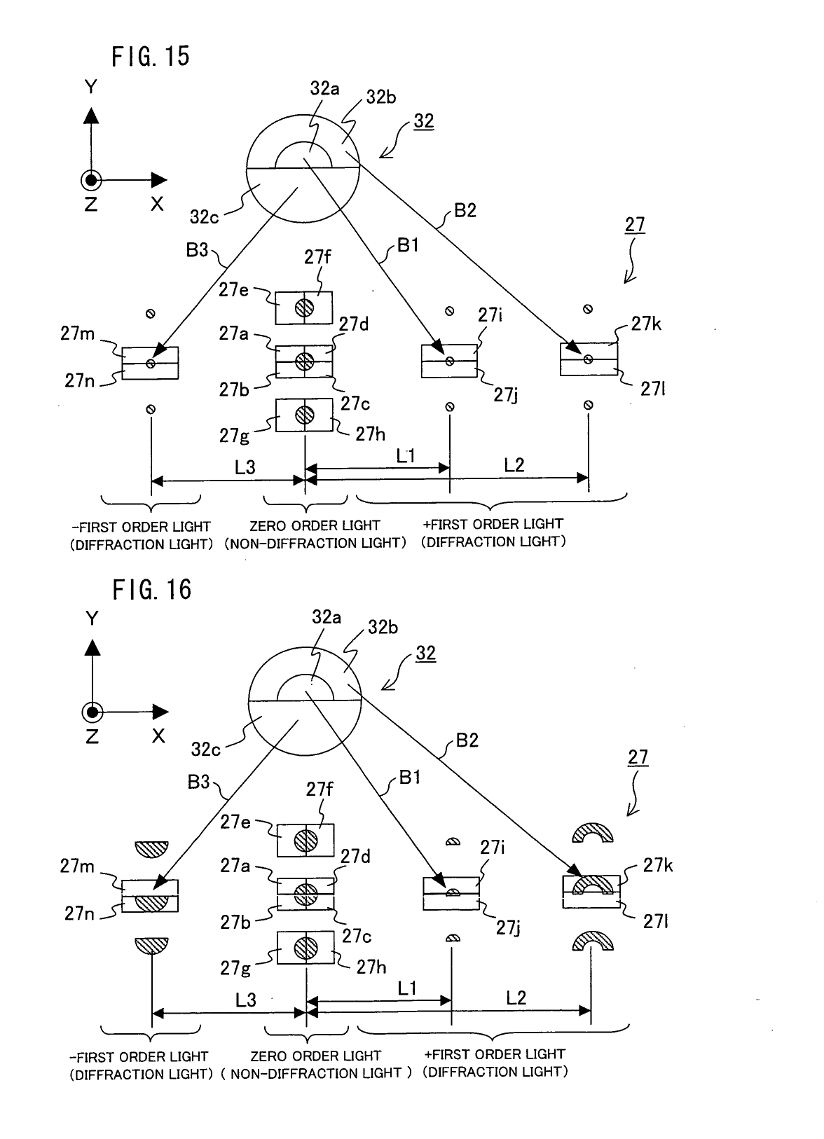

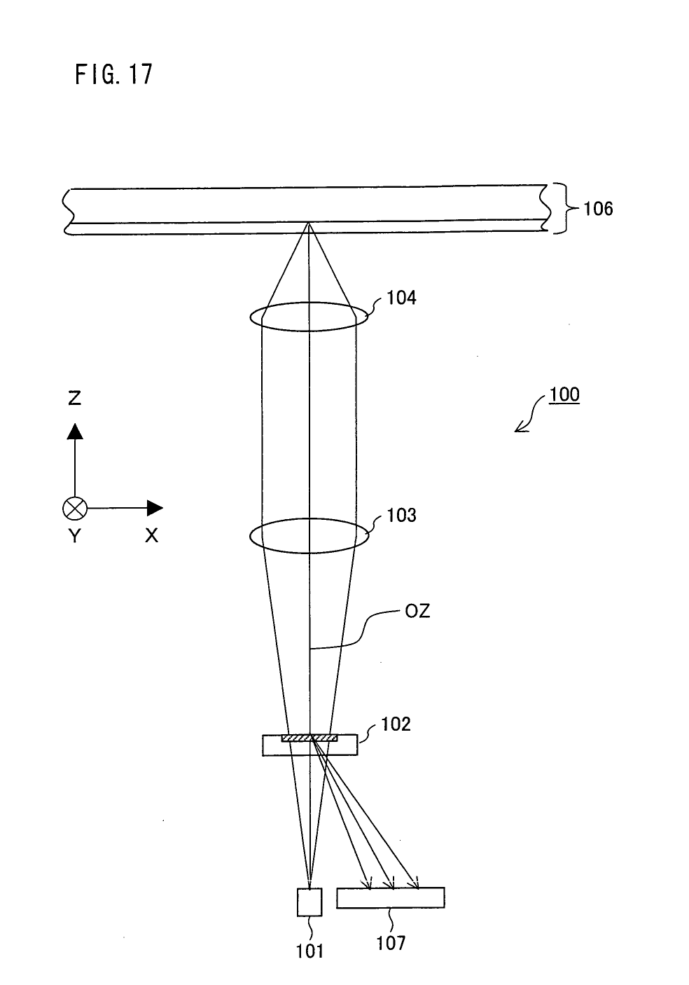

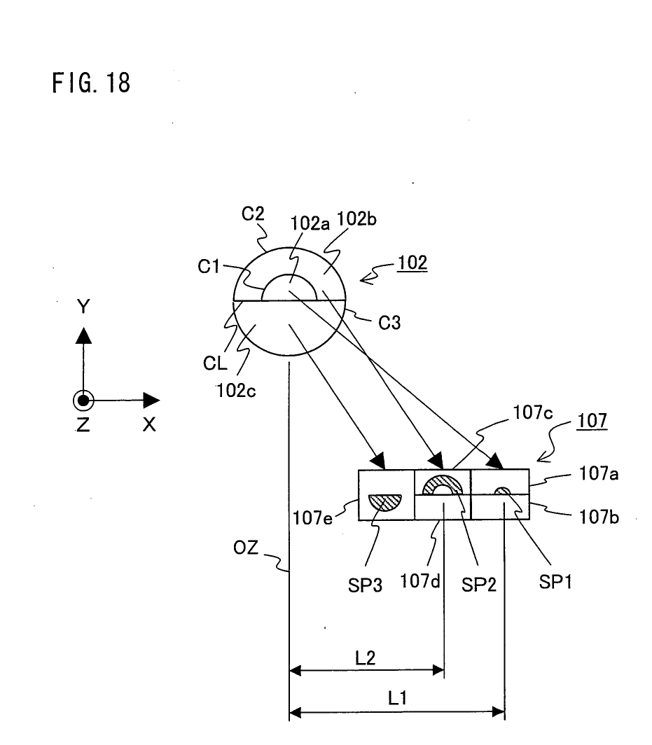

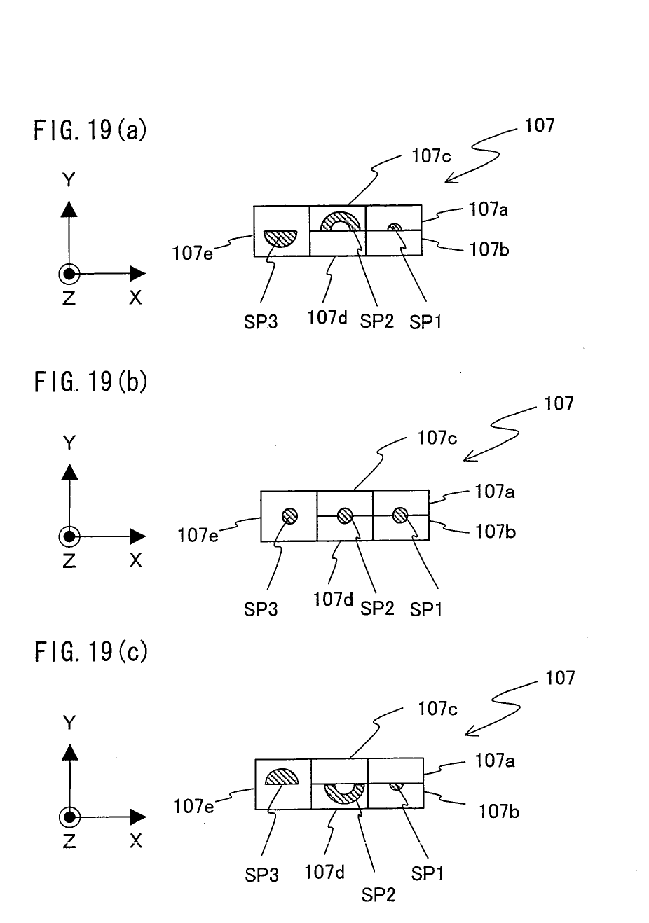

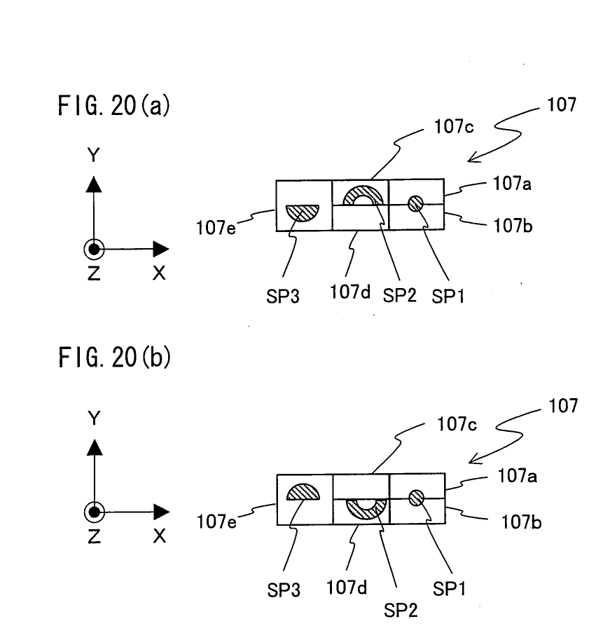

The following will describe relationship between the hologram pattern formed on the second polarization hologram element 32 and the pattern of light received by the light detection section 27 in reference to FIG. 15 and FIG. 16. The second polarization hologram element 32 is actually positioned so that the center thereof is positioned corresponding to the centers of the light receiving areas 27a to 27d. In the figures, the element 32 is displaced in the Y direction for the convenience of description. Here, the term “in-focus” refers to a condition where a light beam is condensed onto the information recording layer 6c or the information recording layer 6d by the objective lens 4.

FIG. 15 illustrates the zero order diffraction light and plus/minus first order diffraction light when the objective lens 4 is positioned at such a distance from the information recording layer 6c or 6d that light is in-focus on that layer.

In the part of the optical system which creates light hitting the optical disc 6, the three light beams (first light beam and two second light beams) produced by the first polarization hologram element 31 are reflected from the information recording layer 6c or 6d on the optical disc 6. In the part of the optical system which handles reflected light from the optical disc 6, the three light beams are divided into non-diffraction light (zero order diffraction light) and diffraction light (plus/minus first order diffraction light) by the second polarization hologram element 32. Specifically, the second polarization hologram element 32 produces three beams of zero order diffraction light, three beams of plus first order diffraction light, and three beams of minus first order diffraction light. The element 32 is designed so that the zero order diffraction light provides light beams of a sufficient size, thereby enabling detection of the tracking error signal TES with a push-pull method.

The light detection section 27, as shown in FIG. 15, has 14 light receiving areas 27a to 27n. The section 27 receives only those components of the zero order diffraction light and the plus/minus first order diffraction light which are needed to detect an RF signal and a servo signal. In the present embodiment, the light receiving areas 27a to 27h are slightly displaced in a negative direction on the optical axis (Z direction) relative to the condensing point of the zero order diffraction light so that the beam radius of the zero order diffraction light has a sufficient size on the light receiving area. The light receiving areas 27a to 27h may however be slightly displaced in a positive direction on the optical axis (Z direction). Thus, light beams with a sufficient beam radius are condensed onto interface sections of the light receiving areas 27a to 27d. Therefore, the positions of the zero order diffraction light and the light detection section 27 can be adjusted through such adjustment that equal outputs are achieved from the four light receiving areas 27a to 27d.

FIG. 16 illustrates the zero order diffraction light and the plus/minus first order diffraction light when the objective lens 4 is positioned at a shorter distance from the information recording layer 6c or 6d than the foregoing in-focus distance. Note however that if the lens-layer distance is longer or shorter than the in-focus distance, the radius of the light beam increases, but the light beam does not expand beyond the light receiving areas.

Next, the generation of a servo signal will be described in reference to FIG. 15 and FIG. 16. In the following, electric signals derived from conversion in the light receiving areas 27a to 27h will be indicated as SP0a to SP0h respectively; those derived from conversion in the light receiving areas 27i and 27j as SP1i and SP1j respectively; those derived from conversion in the light receiving areas 27k and 27l as SP2k and SP21 respectively; and those derived from conversion in the light receiving area 27m and 27n as SP3m and SP3n respectively.

An RF signal RF is detected using the zero order diffraction light. The RF signal RF is calculated from the equation:
RF=SP0a+SP0b+SP0c+SP0d

The tracking error signal TES as detected by phase shift DPP is calculated from the equation:
TES={(SP0a+SP0b)−(SP0c+SP0d)}−α{(SP0e−SP0f)+(SP0g−SP0h)}
where α is a coefficient which is set to an optimal value for canceling offset caused by objective lens shifting and optical disc tilting.

Further, the focus error signal FES is detected with a double knife edge scheme. The signal FES is calculated from the equation:
FES=(SP3m−SP3n)−{(SP1i−SP1j)+(SP2k−SP2l)}

The following will describe distances L1, L2, and L3 between the optical axis OZ and the optical axis centers of the diffraction light divided by the second polarization hologram element 32.

The light diffracted in the area 32a of the second polarization hologram element 32 is designated diffraction light B1, the light diffracted in the area 32b as diffraction light B2, and the light diffracted in the area 32c as diffraction light B3.

The distance L1 indicates the shortest distance between the optical axis OZ and a condensing spot SP1 formed by the diffraction light B1. The distance L2 indicates the shortest distance between the optical axis OZ and a condensing spot SP2 formed by the diffraction light B2. The distance L3 indicates the shortest distance between the optical axis OZ and a condensing spot SP3 formed by the diffraction light B3.

In the present embodiment, the distance L2 is set up to be substantially twice longer than the distance L1. Accordingly, even if there is positional error in height along the optical axis (Z direction) of the second polarization hologram element 32, the condensing spot SP1 is condensed across the interface between the light receiving area 27a and the light receiving area 27b, the condensing spot SP2 is condensed across the interface between the light receiving area 27c and the light receiving area 27d, through such rotation about the optical axis OZ that the condensing spots SP1 and SP2 are shifted parallel to the track (Y direction). Provided here that a third output signal is SP1i−SP1j, and a fourth output signal is SP2k−SP2l, offset is corrected in both the third output signal SP1i−SP1j and the fourth output signal SP2k−SP2l, thereby correcting spherical aberration detect error. Further, since both the third output signal SP1i−SP1j and the fourth output signal SP2k−SP2l change linearly with changes in spherical aberration, the spherical aberration error signal SAES, computed as a difference signal between the third output signal SP1i−SP1j and the fourth output signal SP2k−SP2l, has a constant signal sensitivity, which enables stable spherical aberration control.

The present embodiment has described adjustment through the rotation of the second polarization hologram element 32 around the optical axis OZ. The embodiment is by no means limited to this. The second polarization hologram element 32 may be fixed with the light detection section 27 being rotated about the optical axis OZ. Alternatively, both the second polarization hologram element 32 and the light detection section 27 may be rotated about the optical axis OZ.

As discussed above, the aberration detection device of the present embodiment includes: the hologram element 2 and the second polarization hologram element 32 (division means) for dividing, into diffraction light A1 and B1 (first light beam) and diffraction light A2 and B2 (second light beam), a light beam having passed through the objective lens 4 (condensing optical system), where the diffraction light A1 and B1 is that component of the light beam which includes the optical axis OZ of the light beam and the diffraction light A2 and B2 is an outer component of the light beam than the optical axis OZ; and the control signal generating section 55 (spherical aberration detection means) for detecting spherical aberration of the objective lens 4 from condensing spots (radiation position) of the two light beams, where the condensing spots are those positions on the detection means which the diffraction light A1 and B1 and the diffraction light A2 and B2 are radiated, the shortest distance L2 between the optical axis OZ and the condensing spot SP2 of the diffraction light A2 and B2 being longer than the shortest distance L1 between the optical axis OZ and the condensing spot SP1 of the diffraction light A1 and B1, and the hologram element 2 and the second polarization hologram element 32 being rotatable about the optical axis OZ.

Spherical aberration occurs in the light beam having passed through a cover layer 6b and the objective lens 4 which have a thickness which does not match its design. By the hologram element 2 and the second polarization hologram element 32, the light beam is divided into the diffraction light A1 and B1 and the diffraction light A2 and B2. The diffraction light A1 and B1 is that component of the light beam which includes the optical axis OZ of the light beam. The diffraction light A2 and B2 is an outer component of the light beam than the optical axis OZ. The diffraction light A1 and B1 and the diffraction light A2 and B2 are respectively received at the different light detection sections 7 and 27 (condensing positions). Based on the condensing positions, influence on the spherical aberration can be corrected.

However, if the hologram element 2 and the second polarization hologram element 32 were mounted with positional error in height along the optical axis OZ, this would lead to out-of-focusing. This out-of-focusing causes offset. As a result, the detection of the spherical aberration cannot be performed without errors, thereby becoming inaccurate.

Therefore, it is necessary to eliminate the offset. For example, the light detection sections 7 and 27 may be moved parallel in order to eliminate the offset in the diffraction light A1 and B1. However, this cannot eliminate offset in the diffraction light A2 and B2, because the condensing spot SP2 of the diffraction light A2 and B2 is not moved enough to eliminate the offset in the diffraction light A2 and B2.

In contrast, with the arrangement of the present invention, the hologram element 2 and the second polarization hologram element 32 are rotatable about the optical axis OZ. The rotation of the hologram element 2 and the second polarization hologram element 32 causes the condensing spots SP1 and SP2 to move about the optical axis OZ.

In this arrangement, the shortest distance L2 between the optical axis OZ and the condensing spot SP2 is longer than the shortest distance L1 between the optical axis OZ and the condensing spot SP1. With this arrangement, the rotation of the hologram element 2 and the second polarization hologram element 32 about the optical axis OZ causes not much movement of the condensing spot SP1, but larger movement of the condensing spot SP2.

Because of this, if the condensing spot SP1 is so moved as to eliminate the offset in the diffraction light A1 and B1, the condensing spot SP2 is also moved enough to eliminate the offset in the diffraction light A2 and B2. Thus, the offset is corrected in the signal obtained from the light detection sections 7 and 27, thereby correcting the error in the detection of the spherical aberration. Moreover, the signal is linearly changed according to a change in the spherical aberration. Thus, the spherical aberration error signal SAES attains a constant signal sensitivity, whereby it is possible to perform stable spherical aberration control.

Moreover, the aberration detection device is arranged, as discussed above, so that the shortest distance L2 between the optical axis OZ and the condensing spot SP2 of the diffraction light A2 and B2 is substantially twice longer than the shortest distance L1 between the optical axis OZ and the condensing spot SP1 of the diffraction light A1 and B1.

Experiments showed that even if the hologram element 2 and the second polarization hologram element 32 are mounted with positional error in height, it is possible to alleviate (i.e., absorb) the error in the detection of the spherical aberration with this arrangement, in which the shortest distance L2 between the optical axis OZ and the condensing spot SP2 is substantially twice longer than the shortest distance L1 between the optical axis OZ and the condensing spot SP1.

The optical pickup device 10 of the present embodiment is provided with: the semiconductor laser 1 (light source); the objective lens 4 for condensing, on the optical disc 6 (recording medium), a light beam radiated from the semiconductor laser 1; the hologram element 2 and the second polarization hologram element 32 for dividing, into the diffraction light A1 and B1 and the diffraction light A2 and B2, a light beam having reflected from the optical disc 6 and passed through the objective lens 4, where the diffraction light A1 and B1 is that component of the light beam which includes the optical axis OZ of the light beam and the diffraction light A2 and B2 is an outer component of the light beam than the optical axis OZ; the control signal generating section 55 for detecting spherical aberration of the objective lens 4 from the condensing spots SP1 and SP2 of the two light beams, where the condensing spots SP1 and SP2 are those positions on the detection means which the diffraction light A1 and B1 and the diffraction light A2 and B2 are radiated; and the aberration correcting operation control section 54 for correcting the spherical aberration detected by the control signal generating section 55. The optical pickup device is further arranged such that the shortest distance L2 between the optical axis OZ and the condensing spot SP2 of the diffraction light A2 and B2 longer than the shortest distance L1 between the optical axis OZ and the condensing spot SP1 of the diffraction light A1 and B1, and the hologram element 2 and the second polarization hologram element 32 are rotatable about the optical axis OZ.

With this arrangement, the hologram element 2 and the second polarization hologram element 32 are rotatable about the optical axis OZ. The rotation of the hologram element 2 and the second polarization hologram element 32 causes the condensing spots SP1 and SP2 to move about the optical axis OZ.

In this arrangement, the shortest distance L2 between the optical axis OZ and the condensing spot SP2 is longer than the shortest distance L1 between the optical axis OZ and the condensing spot SP1. With this arrangement, the rotation of the hologram element 2 and the second polarization hologram element 32 about the optical axis OZ causes not much movement of the condensing spot SP1, but larger movement of the condensing spot SP2.

Because of this, if the condensing spot SP1 is so moved as to eliminate the offset in the diffraction light A1 and B1, the condensing spot SP2 is also moved enough to eliminate the offset in the diffraction light A2 and B2. Thus, the offset is corrected in the signal obtained from the light detection sections 7 and 27, thereby correcting the error in the detection of the spherical aberration. Moreover, the signal is linearly changed according to a change in the spherical aberration. Thus, the spherical aberration error signal SAES attains a constant signal sensitivity, whereby it is possible to perform stable spherical aberration control.

Moreover, the optical pickup device 10 is arranged, as discussed above, so that the shortest distance L2 between the optical axis OZ and the condensing spot SP2 of the diffraction light A2 and B2 is substantially twice longer than the shortest distance L1 between the optical axis OZ and the condensing spot SP1 of the diffraction light A1 and B1.

Experiments showed that even if the hologram element 2 and the second polarization hologram element 32 are mounted with positional error in height, it is possible to alleviate (i.e., absorb) the error in the detection of the spherical aberration with this arrangement, in which the shortest distance L2 between the optical axis OZ and the condensing spot SP2 is substantially twice longer than the shortest distance L1 between the optical axis OZ and the condensing spot SP1.

The optical pickup device 10 is arranged, as discussed above, such that at least one of the hologram element 2, the second polarization hologram element 32, and the light detection sections 7 and 27 is rotated at such a position where the rotation thereof does not cause offset in the focus error signal FES.

With this arrangement, in which at least one of the hologram element 2, the second polarization hologram element 32, and the light detection sections 7 and 27, is rotated at such a position where the rotation does not cause offset in the focus error signal FES, no offset occurs in the focus error signal FES, whereby the spherical aberration detect error SAES is corrected.

Furthermore, the aberration detection device may include: light beam division means for, dividing, into a first light beam and a second light beam, a light beam having passed through a condensing optical system, where the first light beam is that component of the light beam which includes the optical axis of the light beam and the second light beam is that component of the light beam other than the component of the first light beam; and spherical aberration detection means for detecting spherical aberration of the condensing optical system from focal point positions of the first and second light beams into which the light beam has been divided by the light beam division means, wherein the light beam division means divides the light beam so that the distance from the optical axis to a condensing point of the second light beam is greater than the distance from the optical axis to a first condensing point.

In the aberration detection device, L2 may be substantially twice longer than L1 where L1 is the distance from the optical axis to a condensing point of the first light beam and L2 is the distance from the optical axis to the condensing point of the second light beam.

In the aberration detection device, the light beam division means may be set up to rotate about the optical axis so that the spherical aberration detection means can detect a predetermined spherical aberration.

The optical pickup device may include: a light source; a condensing optical system for condensing, on an optical recording medium, a light beam radiated from the light source; light beam division means for dividing, into a first light beam and a second light beam, a light beam having passed through the condensing optical system, where the first light beam is that component of the light beam which includes the optical axis of the light beam and the second light beam is that component of the light beam which does not include the optical axis; spherical aberration detection means for detecting spherical aberration of the condensing optical system from focal point positions of the first and second light beams into which the light beam has been divided by the light beam division means; spherical aberration correcting means for correcting the spherical aberration detected by the spherical aberration detection means; and light beam division means for dividing the light beam so that the distance from the optical axis of the light beam to a condensing point of the second light beam is greater than the distance from the optical axis to a first condensing point.

In the optical pickup device, L2 may be substantially twice longer than L1 where L1 is the distance from the optical axis to a condensing point of the first light beam and L2 is the distance from the optical axis to the condensing point of the second light beam.

In the optical pickup device, the light beam division means may be set up to rotate about the optical axis so that the spherical aberration detection means can detect a predetermined spherical aberration.

Moreover, in an aberration detection device according to the present invention, it is preferable that the shortest distance between the optical axis and the radiation position of the second light beams be substantially twice longer than the shortest distance between the optical axis and the radiation position of the first light beam.

Experiments showed that even if the division means is mounted with positional error in height, it is possible to alleviate (i.e., absorb) the error in the detection of the spherical aberration with this arrangement, in which the shortest distance between the optical axis and the radiation position of the second light beams is substantially twice longer than the shortest distance between the optical axis and the radiation position of the first light beam.

Moreover, in an optical pickup device according to the present invention, it is preferable that the shortest distance between the optical axis and the radiation position of the second light beams be substantially twice longer than the shortest distance between the optical axis and the radiation position of the first light beam.

Experiments showed that even if the division means is mounted with positional error in height, it is possible to alleviate (i.e., absorb) the error in the detection of the spherical aberration with this arrangement, in which the shortest distance between the optical axis and the radiation position of the second light beams is substantially twice longer than the shortest distance between the optical axis and the radiation position of the first light beam.

The optical pickup device according to the present invention is preferably arranged such that at least one of the division means and detection means is rotated at such a position where the rotation thereof does not cause offset in a focus error signal.

With this arrangement, in which at least one of the division means and detection means is rotated at such a position where the rotation thereof does not cause offset in a focus error signal, no offset occurs in the focus error signal, whereby the error in the detection of the spherical aberration is corrected.

The present invention is not limited to the description of the embodiments above, but may be altered by a skilled person within the scope of the claims. An embodiment based on a proper combination of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. An aberration detection device, comprising:
division means for dividing, into a first light beam and a second light beam, a light beam having passed through a condensing optical system, where the first light beam is that component of the light beam which includes an optical axis of the light beam and the second light beam is an outer component of the light beam than the optical axis; and
spherical aberration detection means for detecting spherical aberration of the condensing optical system from radiation positions of the first and second light beams, where the radiation positions are those positions on detection means on which the first and second light beams are radiated,
a shortest distance between the optical axis and the radiation position of the second light beams being longer than a shortest distance between the optical axis and the radiation position of the first light beam, and
at least one of the division means and detection means being rotatable about the optical axis.

2. The aberration detection device as set forth in claim 1, wherein:
the shortest distance between the optical axis and the radiation position of the second light beams is substantially twice longer than the shortest distance between the optical axis and the radiation position of the first light beam.

3. An optical pickup device comprising:
a light source;
a condensing optical system for condensing, on a recoding medium, a light beams radiated from the light source;
division means for dividing, into a first light beam and a second light beam, a light beam having passed through the condensing optical system, where the first light beam is that component of the light beam which includes an optical axis of the light beam and the second light beam is an outer component of the light beam than the optical axis;
spherical aberration detection means for detecting spherical aberration of the condensing optical system from radiation positions of the first and second light beams, where the radiation positions are those positions on detection means on which the first and second light beams are radiated; and
spherical aberration correction means for correcting the spherical aberration detected by the spherical aberration detection means,
a shortest distance between the optical axis and the radiation position of the second light beams being longer than a shortest distance between the optical axis and the radiation position of the first light beam, and
at least one of the division means and detection means being rotatable about the optical axis.

4. The optical pickup device as set forth in claim 3, wherein:
the shortest distance between the optical axis and the radiation position of the second light beams is substantially twice longer than the shortest distance between the optical axis and the radiation position of the first light beam.

5. The optical pickup device as set forth in claim 3, wherein:
at least one of the division means and detection means is rotated at such a position where the rotation thereof does not cause offset in a focus error signal.
